(19) United States
(12) Patent Application Publication
(10) Pub. No.: US 2026/0333220 A1
(43) Pub. Date: Oct. 22, 2026

(54) NETWORK-ENERGY SAVINGS FOR REDUCED COMPLEXITY OPERATION

(71) Applicant: Samsung Electronics Co., Ltd., Suwon-si (KR)

(72) Inventors: Marian Rudolf, Longueuil (CA); Emad Nader Farag, Flanders, NJ (US); Aristides Papasakellariou, Houston, TX (US); Ebrahim MolavianJazi, San Jose, CA (US); Hongbo Si, Allen, TX (US)

(21) Appl. No.: 19/633,733

(22) Filed: Mar. 30, 2026

Related U.S. Application Data
(60) Provisional application No. 63/791,080, filed on Apr. 18, 2025.

(51) Int. Cl. H04W 52/02; H04W 72/0453; H04W 72/20; H04W 76/28

(52) U.S. Cl. CPC H04W 52/0229; H04W 72/0453; H04W 72/20; H04W 76/28

(57) ABSTRACT

Apparatuses and methods for network-energy savings for reduced complexity operation for network access including for sixth generation (6G) radio access. A method performed by a user equipment includes receiving first information related to frequency-domain allocations associated with a downlink (DL) bandwidth for receptions or an uplink (UL) bandwidth for transmissions by a reduced bandwidth or complexity UE on a cell and receiving second information for a set of parameters associated with operation states on the cell. An operation state from the operation states includes parameters associated with receptions or transmissions of channels or signals on the cell. The method further includes receiving an indication for the operation state on the cell, determining, based on the indication, a first frequency-domain allocation for receptions or transmissions, and one of receiving a DL signal or channel or transmitting an UL signal or channel based on the first frequency-domain allocation.

### CROSS-REFERENCE TO RELATED AND CLAIM OF PRIORITY

The present application claims priority under 35 U.S.C. § 119(e) to U.S. Provisional Patent Application No. 63/791,080 filed on Apr. 18, 2025, which is hereby incorporated by reference in its entirety.

### TECHNICAL FIELD

The present disclosure relates generally to wireless communication systems and, more specifically, the present disclosure is related to network-energy savings for reduced complexity operation for network access including for sixth generation (6G) radio access in a wireless communication system.

### BACKGROUND

6G is recently gathering increased momentum with all the worldwide technical activities on the various candidate technologies from industry and academia. The candidate enablers for the 6G mobile communications include massive antenna technologies, from legacy cellular frequency bands up to high frequencies, to provide beamforming gain and support increased capacity, waveform design to flexibly accommodate various services/applications with different requirements, new multiple access schemes to support massive connections, artificial intelligence (AI)/machine learning (ML), and so on.

### SUMMARY

The present disclosure relates to network-energy savings for reduced complexity operation for network access including for 6G radio access in a wireless communication system.

In one embodiment, a method of operating a user equipment (UE) is provided. The method includes receiving first information related to frequency-domain allocations associated with a downlink (DL) bandwidth for receptions or an uplink (UL) bandwidth for transmissions by a reduced bandwidth or complexity UE on a cell and receiving second information for a set of parameters associated with operation states on the cell. An operation state from the operation states includes parameters associated with receptions or transmissions of channels or signals on the cell in at least one of a power, spatial, time, or frequency domain. The method further includes receiving an indication for the operation state on the cell, determining, based on the indication, a first frequency-domain allocation for receptions or transmissions in one of a carrier bandwidth or a frequency-domain allocation with lower and upper limits, and one of receiving a DL signal or channel based on the first frequency-domain allocation or transmitting an UL signal or channel based on the first frequency-domain allocation.

In another embodiment, a UE is provided. The UE includes a transceiver configured to receive first information related to frequency-domain allocations associated with a DL bandwidth for receptions or an UL bandwidth for transmissions by a reduced bandwidth or complexity UE on a cell, receive second information for a set of parameters associated with operation states on the cell, and receive an indication for an operation state on the cell. The operation state from the operation states includes parameters associated with receptions or transmissions of channels or signals on the cell in at least one of a power, spatial, time, or frequency domain. The UE further includes a processor operably coupled to the transceiver. The processor is configured to determine, based on the indication, a first frequency-domain allocation for receptions or transmissions in one of a carrier bandwidth or a frequency-domain allocation with lower and upper limits. The transceiver is further configured to one of: receive a DL signal or channel based on the first frequency-domain allocation or transmit an UL signal or channel based on the first frequency-domain allocation.

In yet another embodiment, a base station (BS) is provided. The BS includes a transceiver configured to transmit first information related to frequency-domain allocations associated with a DL bandwidth for receptions or an UL bandwidth for transmissions by a reduced bandwidth or complexity UE on a cell, transmit second information for a set of parameters associated with operation states on the cell, transmit an indication for an operation state on the cell. The operation state from the operation states includes parameters associated with receptions or transmissions of channels or signals on the cell in at least one of a power, spatial, time, or frequency domain. The BS further includes a processor operably coupled to the transceiver. The processor is configured to determine, based on the indication, a first frequency-domain allocation for receptions or transmissions in one of a carrier bandwidth or a frequency-domain allocation with lower and upper limits. The transceiver is further configured to one of: transmit a DL signal or channel based on the first frequency-domain allocation or receive an UL signal or channel based on the first frequency-domain allocation.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example transmit receive point (TRP) according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIG. 5 illustrates an example of a transmitter structure for physical downlink shared channel (PDSCH) in a subframe according to embodiments of the present disclosure;

FIG. 6 illustrates an example of a receiver structure for PDSCH in a subframe according to embodiments of the present disclosure;

FIG. 7 illustrates an example of a transmitter structure for physical uplink shared channel (PUSCH) in a subframe according to embodiments of the present disclosure;

FIG. 8 illustrates an example of a receiver structure for a PUSCH in a subframe according to embodiments of the present disclosure;

FIG. 9 illustrates an example of a transmitter structure for beamforming according to embodiments of the present disclosure;

FIG. 10 illustrates a timeline of an example network energy savings (NES) signaling indication for reduced bandwidth receptions or transmissions according to embodiments of the present disclosure;

FIG. 11 illustrates an example method of NES signaling indication for a reduced complexity UE according to embodiments of the present disclosure;

FIG. 12 illustrates a timeline of an example reduced bandwidth reception according to a change in an NES state or mode of a serving cell according to embodiments of the present disclosure;

FIG. 13 illustrates an example method for reduced bandwidth reception according to a change in an NES state or mode of a serving cell according to embodiments of the present disclosure;

FIG. 14 illustrates an example method for hopping instance determination according to cell DTX or DRX operation on a serving cell according to embodiments of the present disclosure; and

FIG. 15 illustrates an example method performed by a UE according to embodiments of the present disclosure.

### DETAILED DESCRIPTION

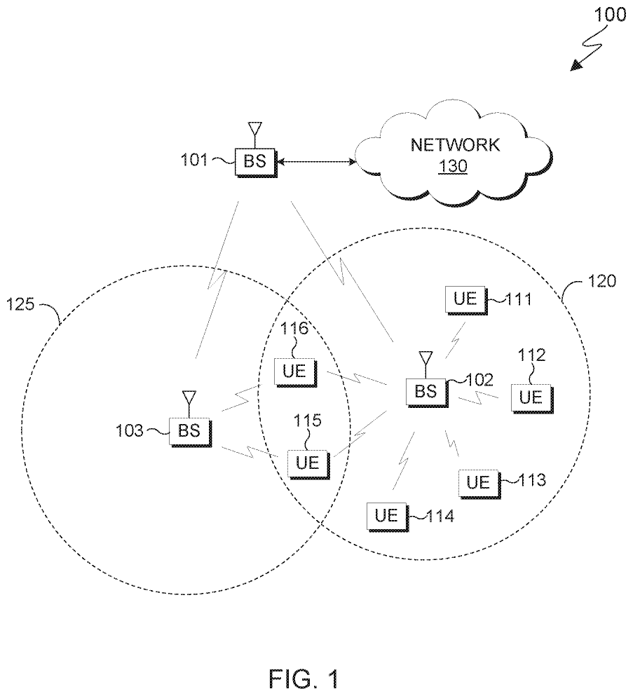

FIGS. 1-15 discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 23-39 GHz or 60 GHz bands, so as to accomplish higher data rates or in lower frequency bands, such as 3.7/3.8 GHz, to enable robust coverage and mobility support.

The discussion of 6G systems and frequency bands associated therewith is for reference as certain embodiments of the present disclosure may be implemented in 6G systems. However, the present disclosure is not limited to 6G systems, or the frequency bands associated therewith, and embodiments of the present disclosure may be utilized in connection with any frequency band. For example, aspects of the present disclosure may be applied to deployment of 6G communication systems, to deployment of 5G/NR communication systems, to deployment of 4G/LTE communication systems, or even for deployment which may use terahertz (THz) bands in later releases.

The following documents and standards descriptions are hereby incorporated by reference into the present disclosure as if fully set forth herein: 3GPP TS 38.211 v18.4.0, “NR; Physical channels and modulation” (herein, “REF 1”); 3GPP TS 38.212 v18.4.0, “NR; Multiplexing and Channel coding” (herein, “REF 2”); 3GPP TS 38.213 v18.4.0, “NR; Physical Layer Procedures for Control” (herein, “REF 3”); 3GPP TS 38.214 v18.4.0, “NR; Physical Layer Procedures for Data” (herein, “REF 4”); 3GPP TS 38.321 v18.3.0, “NR; Medium Access Control (MAC) protocol specification” (herein, “REF 5”); 3GPP TS 38.331 v18.3.0, “NR; Radio Resource Control (RRC) Protocol Specification” (herein, “REF 6”); 3GPP TS 36.211 v18.0.0, “E-UTRA; Physical channels and modulation” (herein, “REF 7”); 3GPP TS 36.212 v18.1.0, “E-UTRA; Multiplexing and Channel coding” (herein, “REF 8”); 3GPP TS 36.213 v18.3.0, “E-UTRA; Physical Layer Procedures” (herein, “REF 9”); 3GPP TS 36.331 v18.4.0, “E-UTRA; Radio Resource Control (RRC) Protocol Specification” (herein, “REF 10”); and 3GPP TS 37.340 v18.3.0, “Evolved Universal Terrestrial Radio Access (E-UTRA) and NR; Multi-connectivity; Overall Description; Stage 2” (herein, “REF 11”).

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of the present disclosure.

As shown in FIG. 1, the wireless network 100 includes a BS 101 (e.g., base station, eNB, gNB, aNB), a BS 102, and a BS 103. The BS 101 communicates with the BS 102 and the BS 103. The BS 101 also communicates with at least one network 130, such as the Internet, a proprietary Internet Protocol (IP) network, or other data network.

The BS 102 provides wireless broadband access to the network 130 for a first plurality of user equipments (UEs) within a coverage area 120 of the BS 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The BS 103 provides wireless broadband access to the network 130 for a second plurality of UEs within a coverage area 125 of the BS 103. The second plurality of UEs includes the UE 115 and the UE 116. In some embodiments, one or more of the BSs 101-103 may communicate with each other and with the UEs 111-116 using 6G, 5G/NR, 4G/long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a 6G base station (aNB), a macrocell, a femtocell, a WiFi access point (AP), or other wirelessly enabled devices. Base stations may provide wireless access in accordance with one or more wireless communication protocols, e.g., 6G, or 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with BSs, such as the coverage areas 120 and 125, may have other shapes, including irregular shapes, depending upon the configuration of the BSs and variations in the radio environment associated with natural and man-made obstructions.

As described in more detail below, one or more of the UEs 111-116 include circuitry, programming, or a combination thereof for operation in a wireless communication system, and more specifically for supporting network-energy savings for reduced complexity operation for network access including for 6G radio access. In certain embodiments, one or more of the BSs 101-103 include circuitry, programming, or a combination thereof to support operation in a wireless communication system, and more specifically to support network-energy savings for reduced complexity operation for network access including for 6G radio access.

Although FIG. 1 illustrates one example of a wireless network, various changes may be made to FIG. 1. For example, the wireless network 100 could include any number of BSs and any number of UEs in any suitable arrangement. Also, the BS 101 could communicate directly with any number of UEs and provide those UEs with wireless broadband access to the network 130. Similarly, each BS 102-103 could communicate directly with the network 130 and provide UEs with direct wireless broadband access to the network 130. Further, the BSs 101, 102, and/or 103 could provide access to other or additional external networks, such as external telephone networks or other types of data networks.

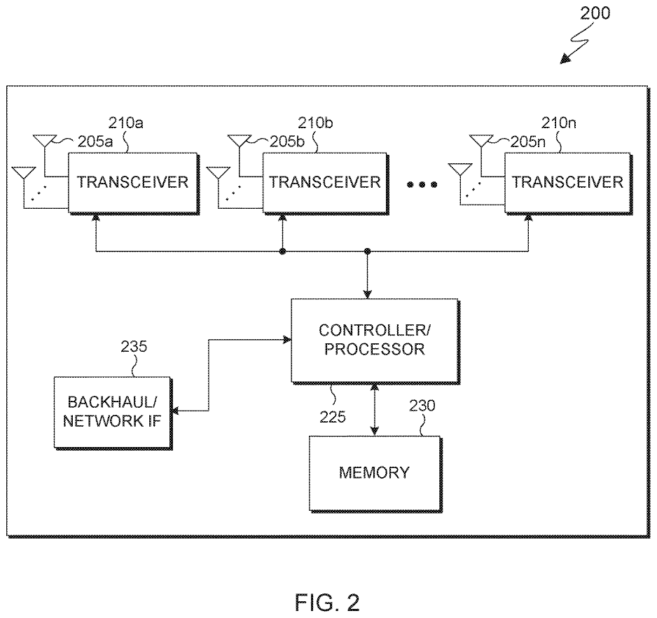

FIG. 2 illustrates an example TRP 200 according to embodiments of the present disclosure. For example, the TRP 200 may be a base station, such as BS 101-103, or may be an NCR or smart repeater (SR). The embodiment of the TRP 200 illustrated in FIG. 2 is for illustration only. However, TRPs come in a wide variety of configurations, and FIG. 2 does not limit the scope of this disclosure to any particular implementation of a TRP.

As shown in FIG. 2, the TRP 200 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs or BSs in the network 100. In various embodiments, certain of the transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals. For example, in embodiments where the TRP is a repeater, one or more of the transceivers 210 may be used for an NCR-RU entity or NCR-Fwd entity as a DL connection for signaling over an access link with a UE and/or over a backhaul link with a BS. In these examples, the associated one(s) of the transceivers 210 for the NCR-RU entity or NCR-Fwd entity may not convert the incoming RF signal to IF or a baseband signal but rather amplify the incoming RF signal and forward or relay the amplified signal, without any down conversion to IF or baseband. In another example, in embodiments where the TRP is a repeater, one or more of the transceivers 210 may be used for an NCR-MT entity as a DL or uplink (UL) connection for control signaling over a control link (C-link) with a BS.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the TRP 200. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for operation in a 6G or 5G/NR wireless communication system, including methods supporting network-energy savings for reduced complexity operation for network access including for 6G radio access. Any of a wide variety of other functions could be supported in the TRP 200 by the controller/processor 225.

The controller/processor 225 is also capable of executing programs and other processes resident in the memory 230, such as processes supporting network-energy savings for reduced complexity operation for network access including for 6G radio access. The controller/processor 225 can move data into or out of the memory 230 as required by an executing process.

The controller/processor 225 is also coupled to the backhaul or network interface 235. The backhaul or network interface 235 allows the TRP 200 to communicate with other devices or systems over a backhaul connection or over a network. The interface 235 could support communications over any suitable wired or wireless connection(s). For example, when the TRP 200 is implemented as part of a cellular communication system (such as one supporting 6G, 5G/NR, LTE, or LTE-A), the interface 235 could allow the TRP 200 to communicate with other BSs over a wired or wireless backhaul connection, for example, using a transceiver, such as described above with regard to transceivers 210. For example, in embodiments where the TRP is a repeater, the interface 235 may be used for an NCR-RU or NCR-Fwd entity as a backhaul connection with a BS over a backhaul link for control signaling and/or data to be transmitted to and/or received from a UE. When the TRP 200 is implemented as an access point, the interface 235 could allow the TRP 200 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of TRP 200, various changes may be made to FIG. 2. For example, the TRP 200 could include any number of each component shown in FIG. 2. Also, various components in FIG. 2 could be combined, further subdivided, or omitted and additional components could be added according to particular needs.

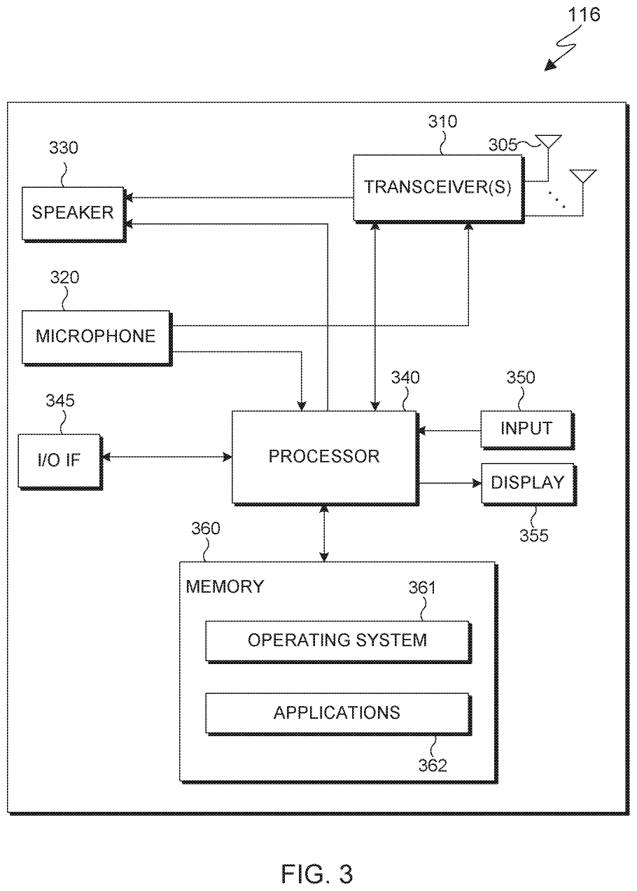

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of the present disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a BS of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channels or signals and the transmission of UL channels or signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for operation in a 6G or 5G/NR wireless communication system, including processes supporting network-energy savings for reduced complexity operation for network access including for 6G radio access as described in embodiments of the present disclosure. The processor 340 can move data into or out of the memory 360 as required by an executing process. In some embodiments, the processor 340 is configured to execute the applications 362 based on the OS 361 or in response to signals received from BSs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

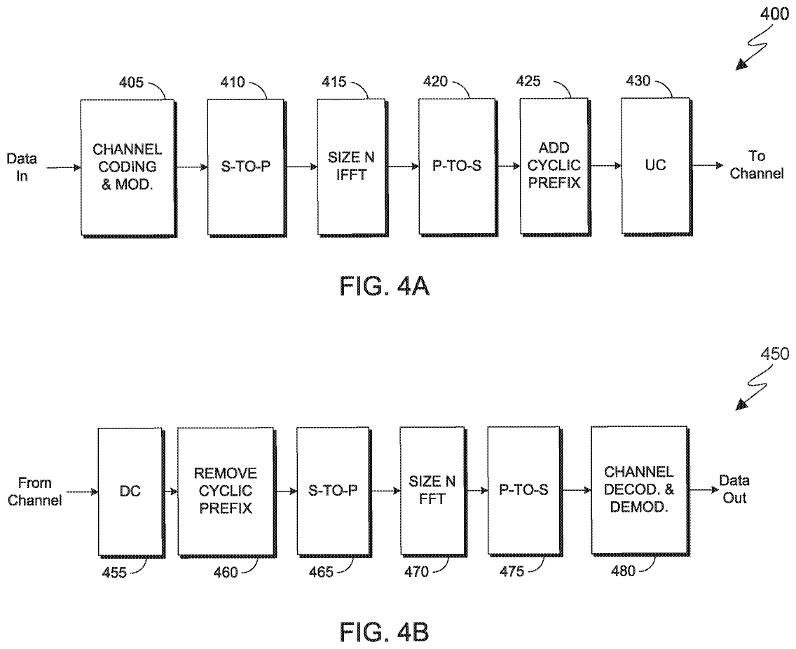

FIG. 4A and FIG. 4B illustrate an example of wireless transmit and receive paths 400 and 450, respectively, according to embodiments of the present disclosure. For example, a transmit path 400 may be described as being implemented in a BS or TRP (such as BS 102 or TRP 200), while a receive path 450 may be described as being implemented in a UE (such as UE 116). However, it will be understood that the receive path 450 can be implemented in a BS or TRP and that the transmit path 400 can be implemented in a UE. In some embodiments, the transmit path 400 and/or the receive path 450 is configured for operation in a 6G or 5G/NR or 4G/LTE wireless communication system, and more specifically for supporting network-energy savings for reduced complexity operation for network access including for 6G radio access as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the BS and the UE. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the BSs 101-103 or the TRP 200 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to the BSs 101-103 or the TRP 200 and may implement a receive path 450 for receiving in the downlink from the BSs 101-103 or the TRP 200.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of the present disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted, and additional components can be added according to particular needs. Also, FIGS. 4A and 4B are meant to illustrate examples of the types of transmit and receive paths that can be used in a wireless network. Any other suitable architectures can be used to support wireless communications in a wireless network.

A communication system can include a downlink (DL) that refers to transmissions from a base station (such as the BS 102) or one or more transmission points to UEs (such as the UE 116) and an uplink (UL) that refers to transmissions from UEs (such as the UE 116) to a base station (such as the BS 102) or to one or more reception points.

A time unit for DL signaling or for UL signaling on a cell is referred to as a slot and can include one or more symbols. A symbol can also serve as an additional time unit. A subframe can include one or more slots and can also serve as an additional time unit. A frequency or bandwidth (BW) unit is referred to as a resource block (RB). One RB includes a number of sub-carriers (SCs). For example, a slot can have duration of 1 millisecond or 0.5 millisecond, include 14 symbols and an RB can include 12 SCs with inter-SC spacing of 15 kHz or 30 kHz, and so on.

DL signals include data signals conveying information content, control signals conveying DL control information (DCI), and reference signals (RS) that are also known as pilot signals. A BS transmits data information or DCI through respective physical DL shared channels (PDSCHs) or physical DL control channels (PDCCHs). A PDSCH or a PDCCH can be transmitted over a variable number of slot symbols including one slot symbol. For brevity, a DCI format scheduling a PDSCH reception by a UE is referred to as a DL DCI format and a DCI format scheduling a physical uplink shared channel (PUSCH) transmission from a UE is referred to as an UL DCI format. A DCI format scheduling PDSCH reception or PUSCH transmission for a single UE, such as a DCI format with CRC scrambled by C-RNTI/CS-RNTI/MCS-C-RNTI as described in REF 2, are referred for brevity as a unicast DCI format. A DCI format scheduling PDSCH reception for multicast communication, such as a DCI format with CRC scrambled by G-RNTI/G-CS-RNTI as described in REF 2, are referred to as multicast DCI format. DCI formats providing various control information to at least a subset of UEs in a serving cell, such as DCI format 2_0 in REF 2, are referred to as group-common (GC) DCI formats.

A BS (such as the BS 102) transmits one or more of multiple types of RS including channel state information RS (CSI-RS) and demodulation RS (DM-RS). A CSI-RS is primarily intended for UEs to perform measurements and provide channel state information (CSI) to a BS. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process includes NZP CSI-RS and CSI-IM resources.

A UE (such as the UE 116) can determine CSI-RS transmission parameters through DL control signaling or higher layer signaling, such as radio resource control (RRC) signaling, from a BS (such as the BS 102). Transmission instances of a CSI-RS can be indicated by DL control signaling or be configured by higher layer signaling. For example, using 6G, 5G/NR, or 4G/LTE, a DM-RS is transmitted only in the BW of a respective PDCCH or PDSCH and a UE can use the DM-RS to demodulate data or control information.

In certain embodiments, UL signals also include data signals conveying information content, control signals conveying UL control information (UCI), DM-RS associated with data or UCI demodulation, sounding RS (SRS) enabling a BS to perform UL channel measurement, and a RA preamble enabling a UE to perform random access. A UE transmits data information or UCI through a respective PUSCH or a physical UL control channel (PUCCH). A PUSCH or a PUCCH can be transmitted over a variable number of slot symbols including one slot symbol. The BS can configure the UE to transmit signals on a cell within an active UL bandwidth part (BWP) of the cell UL BW.

UCI includes HARQ acknowledgement (ACK) information, indicating correct or incorrect detection of data transport blocks (TBs) in a PDSCH, scheduling request (SR) indicating whether a UE has data in a buffer, and CSI reports enabling a BS to select appropriate parameters for PDSCH or PDCCH transmissions to a UE. HARQ-ACK information can be configured to be with a smaller granularity than per TB and can be per data code block (CB) or per group of data CBs where a data TB includes a number of data CBs.

A CSI report from a UE can include a channel quality indicator (CQI) informing a BS of a largest modulation and coding scheme (MCS) for the UE to detect a data TB with a predetermined block error rate (BLER), such as a 10% BLER (see NR specification), of a precoding matrix indicator (PMI) informing a BS how to combine signals from multiple transmitter antennas in accordance with a MIMO transmission principle, and of a rank indicator (RI) indicating a transmission rank for a PDSCH.

UL RS includes DM-RS and SRS. DM-RS is transmitted only in a BW of a respective PUSCH or PUCCH transmission. A BS can use a DM-RS to demodulate information in a respective PUSCH or PUCCH. SRS is transmitted by a UE to provide a BS with an UL CSI, and, for a TDD system, an SRS transmission can also provide a PMI for DL transmission. Additionally, in order to establish synchronization or an initial higher layer connection with a BS, a UE can transmit a physical random-access channel (PRACH) as shown in 5G/NR specifications.

An antenna port is defined such that the channel over which a symbol on the antenna port is conveyed can be inferred from the channel over which another symbol on the same antenna port is conveyed.

For DM-RS associated with a PDSCH, the channel over which a PDSCH symbol on one antenna port is conveyed can be inferred from the channel over which a DM-RS symbol on the same antenna port is conveyed only if the two symbols are within the same resource as the scheduled PDSCH, in the same slot, and in the same precoding resource block group (PRG).

For DM-RS associated with a PDCCH, the channel over which a PDCCH symbol on one antenna port is conveyed can be inferred from the channel over which a DM-RS symbol on the same antenna port is conveyed only if the two symbols are within resources for which the UE may assume the same precoding being used.

For DM-RS associated with a physical broadcast channel (PBCH), the channel over which a PBCH symbol on one antenna port is conveyed can be inferred from the channel over which a DM-RS symbol on the same antenna port is conveyed only if the two symbols are within a SS/PBCH block transmitted within the same slot, and with the same block index.

Two antenna ports are said to be quasi co-located if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters.

The UE (such as the UE 116) may assume that synchronization signal (SS)/PBCH block (also denoted as SSBs) transmitted with the same block index on the same center frequency location are quasi co-located with respect to Doppler spread, Doppler shift, average gain, average delay, delay spread, and, when applicable, spatial Rx parameters. The UE may not assume quasi co-location for any other synchronization signal SS/PBCH block transmissions.

In absence of CSI-RS configuration, and unless otherwise configured, the UE may assume PDSCH DM-RS and SSB to be quasi co-located with respect to Doppler shift, Doppler spread, average delay, delay spread, and, when applicable, spatial Rx parameters. The UE may assume that the PDSCH DM-RS within the same code division multiplexing (CDM) group is quasi co-located with respect to Doppler shift, Doppler spread, average delay, delay spread, and spatial Rx. The UE may also assume that DM-RS ports associated with a PDSCH are QCL with QCL type A, type D (when applicable) and average gain. The UE may further assume that no DM-RS collides with the SS/PBCH block.

A beam may be determined by a transmission configuration indication (TCI) state that establishes a quasi-co-location (QCL) relationship or a spatial relation between a source reference signal, e.g., a synchronization signal block (SS/PBCH Block or SSB) or channel state information reference signal (CSI-RS) and a target reference signal, or a spatial relationship information that establishes an association to a source reference signal, such as an SSB, CSI-RS, or sounding reference signal (SRS). In either case, the ID of the source reference signal can identify the beam.

The TCI state and/or the spatial relationship reference RS can determine a spatial Rx filter for reception of downlink channels or signals at the UE, or a spatial Tx filter for transmission of uplink channels or signals from the UE. The TCI state and/or the spatial relation reference RS can determine a spatial Tx filter for transmission of downlink channels or signals from the BS, or a spatial Rx filter for reception of uplink channels or signals at the BS.

A UE can be indicated a spatial setting for a PDCCH reception based on a configuration of a value for a transmission configuration indication state (TCI state) of a control resource set (CORESET) where the UE receives the PDCCH. The UE can be indicated a spatial setting for a PDSCH reception based on a configuration by higher layers or based on an indication by a DCI format scheduling the PDSCH reception of a value for a TCI state. The BS can configure the UE to receive signals on a cell within a DL bandwidth part (BWP) of the cell DL BW.

The UE can be configured with a list of up to M transmission configuration indication (TCI) State configurations within the higher layer parameter PDSCH-Config to decode PDSCH according to a detected PDCCH with DCI intended for the UE and the given serving cell, where M depends on the UE capability maxNumberConfiguredTCIstatesPerCC. Each TCI-State contains parameters for configuring a quasi-colocation (QCL) relationship between one or two downlink reference signals and the DM-RS ports of the PDSCH, the DM-RS port of PDCCH or the CSI-RS port(s) of a CSI-RS resource.

A quasi-co-location (QCL) relationship may be configured by the higher layer parameter qcl-Type1 for a first DL RS, and qcl-Type2 for a second DL RS (if configured). For the case of two DL RSs, the QCL types may not be the same, regardless of whether the references are to the same DL RS or different DL RSs. The quasi-co-location types corresponding to each DL RS can be given by the higher layer parameter qcl-Type in QCL-Info and may take one of the following values: QCL-TypeA: {Doppler shift, Doppler spread, average delay, delay spread}; QCL-TypeB: {Doppler shift, Doppler spread; QCL-TypeC: {Doppler shift, average delay}; and QCL-TypeD: {Spatial Rx parameter}.

A reference RS may correspond to a set of characteristics of a DL beam or an UL Tx beam, such as a direction, a precoding/beamforming, a number of ports, and so on.

A UE can be provided through higher layer RRC signaling a set of TCI States with N elements. In one example, DL and joint TCI states are configured by higher layer parameter DLorJoint-TCIState, wherein, the number of DL and Joint TCI state is N_{DJ}. UL TCI states are configured by higher layer parameter UL-TCIState, wherein the number of UL TCI states is N_{U}. N=N_{DJ}+N_{U}. The DLorJoint-TCIState can include DL or Joint TCI states for a serving cell. The source RS of the TCI state may be associated with the serving cell, e.g., the PCI of the serving cell. Additionally, the DL or Joint TCI states can be associated with a cell having a PCI different from the PCI of the serving cell, e.g., the source RS of the TCI state is associated with a cell having a PCI different from the PCI of the serving cell. The UL-TCIState can include UL TCI states that belong to a serving cell, e.g., the source RS of the TCI state is associated with the serving cell (the PCI of the serving cell); additionally, the UL TCI states can be associated with a cell having a PCI different from the PCI of the serving cell, e.g., the source RS of the TCI state is associated with a cell having a PCI different from the PCI of the serving cell.

MAC CE signaling can include a subset of M (M≤N) TCI states or TCI state code points from the set of N TCI states, wherein a code point is signaled in the “transmission configuration indication” field of a DCI used for indication of the TCI state. A codepoint can include one TCI state, e.g., DL TCI state or UL TCI state or Joint (DL and UL) TCI state. Alternatively, a codepoint can include two TCI states, e.g., a DL TCI state and an UL TCI state. L1 control signaling, i.e., Downlink Control Information (DCI) can update the UE's TCI state, wherein the DCI includes a “transmission configuration indication” (beam indication) field, e.g., using m bits such that M≤2^{m}. The TCI state may correspond to a code point signaled by MAC CE. A DCI used for indication of the TCI state can be a DCI format 1_1 or DCI format 1_2 or DCI format 1_3 with a DL assignment for PDSCH receptions or without a DL assignment for PDSCH receptions.

The TCI states can be associated through a QCL relation with an SSB or a CSI-RS of serving cell, or an SSB or a CSI-RS associated with a PCI different from the PCI of the serving cell. The QCL relation with an SSB can be a direct QCL relation, wherein the source RS, e.g., for a QCL Type D relation or a spatial relation of the QCL state is the SSB. The QCL relation with an SSB can be an indirect QCL relation wherein the source RS, e.g., for a QCL Type D relation or a spatial relation can be a CSI-RS, and the CSI-RS has the SSB as its source, e.g., for a QCL Type D relation or a spatial relation. The indirect QCL relation to an SSB can involve a QCL or spatial relation chain of more than one CSI-RS.

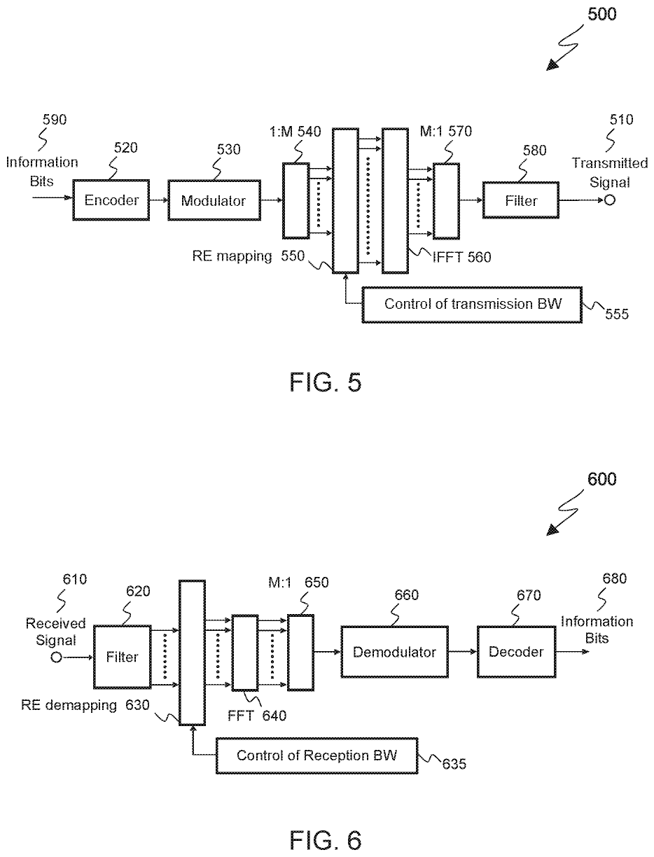

FIG. 5 illustrates an example of a transmitter structure 500 for PDSCH in a subframe according to embodiments of the present disclosure. For example, transmitter structure 500 can be implemented in BS 102 of FIG. 1. This example is for illustration only and other embodiments can be used without departing from the scope of the present disclosure.

As illustrated in FIG. 5, information bits 510 are encoded by encoder 520, such as a turbo encoder, and modulated by modulator 530, for example using Quadrature Phase Shift Keying (QPSK) modulation. A Serial to Parallel (S/P) converter 540 generates M modulation symbols that are subsequently provided to a mapper 550 to be mapped to REs selected by a transmission BW selection unit 555 for an assigned PDSCH transmission BW, unit 560 applies an Inverse Fast Fourier Transform (IFFT), the output is then serialized by a Parallel to Serial (P/S) converter 570 to create a time domain signal, filtering is applied by filter 580, and a signal transmitted 590. Additional functionalities, such as data scrambling, cyclic prefix insertion, time windowing, interleaving, and others are well known in the art and are not shown for brevity.

FIG. 6 illustrates an example of a receiver structure 600 for PDSCH in a subframe according to embodiments of the present disclosure. For example, receiver structure 600 can be implemented by any of the UEs 111-116 of FIG. 1. This example is for illustration only and other embodiments can be used without departing from the scope of the present disclosure.

As illustrated in FIG. 6, a received signal 610 is filtered by filter 620, REs 630 for an assigned reception BW are selected by BW selector 635, unit 640 applies a Fast Fourier Transform (FFT), and an output is serialized by a parallel-to-serial converter 650. Subsequently, a demodulator 660 coherently demodulates data symbols by applying a channel estimate obtained from a DMRS or a CRS (not shown), and a decoder 670, such as a turbo decoder, decodes the demodulated data to provide an estimate of the information data bits 680. Additional functionalities such as time-windowing, cyclic prefix removal, de-scrambling, channel estimation, and de-interleaving are not shown for brevity.

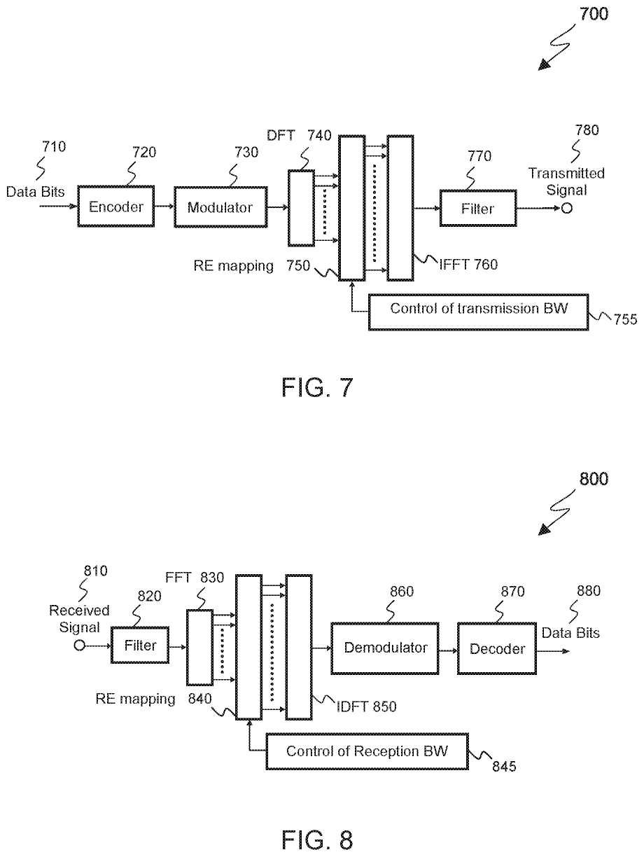

FIG. 7 illustrates an example of a transmitter structure 700 for PUSCH in a subframe according to embodiments of the present disclosure. For example, transmitter structure 700 can be implemented in BS 102 of FIG. 1. This example is for illustration only and other embodiments can be used without departing from the scope of the present disclosure.

As illustrated in FIG. 7, information data bits 710 are encoded by encoder 720, such as a turbo encoder, and modulated by modulator 730. A Discrete Fourier Transform (DFT) unit 740 applies a DFT on the modulated data bits, REs 750 corresponding to an assigned PUSCH transmission BW are selected by transmission BW selection unit 755, unit 760 applies an IFFT and, after a cyclic prefix insertion (not shown), filtering is applied by filter 770 and a signal transmitted 780.

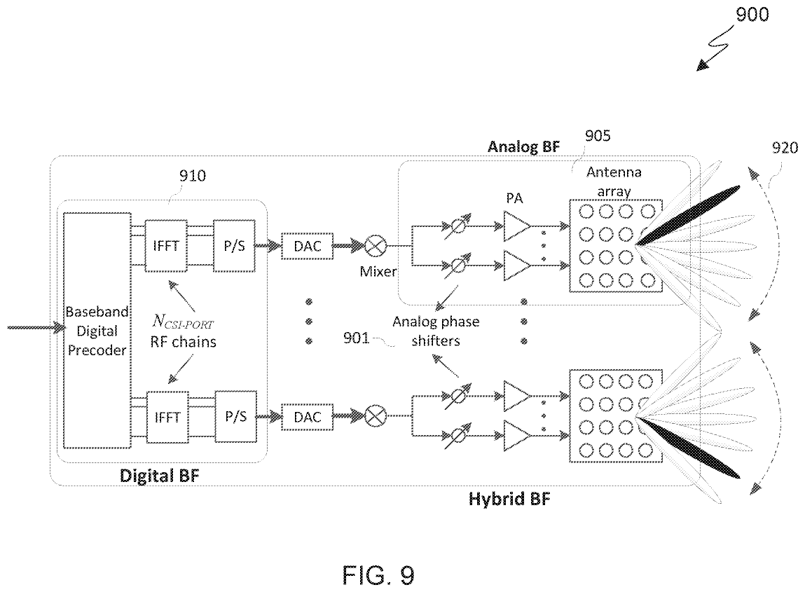

FIG. 8 illustrates an example of a receiver structure 800 for a PUSCH in a subframe according to embodiments of the present disclosure. For example, receiver structure 800 can be implemented by any of the UEs 111-116 of FIG. 1. This example is for illustration only and other embodiments can be used without departing from the scope of the present disclosure.

As illustrated in FIG. 8, a received signal 810 is filtered by filter 820. Subsequently, after a cyclic prefix is removed (not shown), unit 830 applies a FFT, REs 840 corresponding to an assigned PUSCH reception BW are selected by a reception BW selector 845, unit 850 applies an Inverse DFT (IDFT), a demodulator 860 coherently demodulates data symbols by applying a channel estimate obtained from a DMRS (not shown), a decoder 870, such as a turbo decoder, decodes the demodulated data to provide an estimate of the information data bits 880.

FIG. 9 illustrates an example of a transmitter structure 900 for beamforming according to embodiments of the present disclosure. In certain embodiments, one or more of BS 102, TRP 200, or UE 116 includes the transmitter structure 900. For example, one or more of antenna 205 and its associated systems or antenna 305 and its associated systems can be included in transmitter structure 900. This example is for illustration only and other embodiments can be used without departing from the scope of the present disclosure.

Accordingly, embodiments of the present disclosure recognize that Rel-14 LTE and Rel-15 NR support up to 32 CSI reference signal (CSI-RS) antenna ports which enable an eNB or a BS to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 9. Then, one CSI-RS port can be mapped onto a large number of antenna elements that can be controlled by a bank of analog phase shifters 901. One CSI-RS port can then correspond to one sub-array which produces a narrow analog beam through analog beamforming 905. This analog beam can be configured to sweep across a wider range of angles 920 by varying the phase shifter bank across symbols or slots/subframes. The number of sub-arrays (equal to the number of RF chains) is the same as the number of CSI-RS ports N_{CSI-PORT}. A digital beamforming unit 910 performs a linear combination across N_{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 900 of FIG. 9 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 9 is also applicable to higher frequency bands such as >52.6 GHz (also termed frequency range 4 or FR4). In this case, the system can employ only analog beams. Due to the O2 absorption loss around 60 GHz frequency (~10 dB additional loss per 100 m distance), a larger number and narrower analog beams (hence a larger number of radiators in the array) are essential to compensate for the additional path loss.

In the present disclosure, the frequency resolution (reporting granularity) and span (reporting bandwidth) of CSI or calibration coefficient reporting can be defined in terms of frequency “subbands” and “CSI reporting band,” respectively.

A subband for CSI or calibration coefficient reporting is defined as a set of contiguous PRBs which represents the smallest frequency unit for CSI or calibration coefficient reporting. The number of PRBs in a subband can be fixed for a given value of DL system bandwidth, configured either semi-statically via higher layer/RRC signaling, or dynamically via L1 DL control signaling or MAC control element (MAC CE). The number of PRBs in a subband can be included in CSI or calibration coefficient reporting setting. The term “CSI reporting band” is defined as a set/collection of subbands, either contiguous or non-contiguous, wherein CSI or calibration coefficient reporting is performed. For example, CSI or calibration coefficient reporting band can include all the subbands within the DL system bandwidth. This can also be termed “full-band”. Alternatively, CSI or calibration coefficient reporting band can include only a collection of subbands within the DL system bandwidth. This can also be termed “partial band”. The term “CSI reporting band” is used only as an example for representing a function. Other terms such as “CSI reporting subband set” or “CSI or calibration coefficient reporting bandwidth” can also be used.

In terms of UE configuration, a UE can be configured with at least one CSI or calibration coefficient reporting band. This configuration can be semi-static (via higher layer signaling or RRC) or dynamic (via MAC CE or L1 DL control signaling). When configured with multiple (N) CSI or calibration coefficient reporting bands (e.g., via RRC signaling), a UE can report CSI associated with n≤N CSI reporting bands. For instance, >6 GHz, large system bandwidth may require multiple CSI or calibration coefficient reporting bands. The value of n can either be configured semi-statically (via higher layer signaling or RRC) or indicated dynamically (via MAC CE or L1 DL control signaling). Alternatively, the UE can report a recommended value of n via an UL channel.

Therefore, CSI parameter frequency granularity can be defined per CSI reporting band as follows. A CSI parameter is configured with “single” reporting for the CSI reporting band with Mn subbands when one CSI parameter for all the Mₙ subbands within the CSI reporting band. A CSI parameter is configured with “subband” for the CSI reporting band with Mn subbands when one CSI parameter is reported for each of the Mn subbands within the CSI reporting band.

In the following and throughout the disclosure, various embodiments of the disclosure may be also implemented in any type of UE including, for example, 6G UEs, or UEs with the same, similar, fewer or more capabilities compared to a Rel-21 6G or a Rel-15 5G/NR UE. Although various embodiments of the disclosure discuss 3GPP 6G or 5G/NR wireless communication systems, the embodiments may apply in general to UEs operating with other RATs and/or standards, such as 4G/LTE or next releases/generations of 3GPP, IEEE Wi-Fi, and so on.

For example, RRC signaling such as configuration by RRC signaling may include (1) common information provided by common signaling, e.g., this can be system information block (SIB)-based RRC signaling (e.g., SIB1 or other SIB) or (2) RRC dedicated signaling that is sent to a specific UE wherein the information can be common/cell-specific information or dedicated/UE-specific information or (3) UE-group RRC signaling.

For example, MAC CE signaling can be UE-specific e.g., to one UE and can be UE common (e.g., to a group of UEs or to UEs in a cell). MAC CE signaling can be DL MAC CE signaling or UL MAC CE signaling.

For example, L1 control signaling may include: (1) DL control information (e.g., DCI on PDCCH or DL control information on PDSCH) and/or (2) UL control information (e.g., UCI on PUCCH or PUSCH). L1 control signaling can be UE-specific e.g., to one UE and can be UE common (e.g., to a group of UEs or to all UEs in a cell).

For example, the term ‘configuration’ can refer to configuration by semi-static signaling such as RRC. In one example, a configuration can be applicable to multiple reception instances or multiple transmission instances, until a configuration is received and applied. For example, the term ‘activation’ can describe an operation wherein a UE receives and decodes a signal from the network (or BS) that signifies a starting point in time. The starting point can be a present or a future slot/subframe or symbol and the exact location is either implicitly or explicitly indicated, or is otherwise specified in the system operation or is configured by higher layers. Upon successfully decoding the signal, the UE responds according to an indication provided by the signal. The term “deactivation” can describe an operation wherein a UE receives and decodes a signal from the network (or BS) that signifies a stopping point in time. The stopping point can be a present or a future slot/subframe or symbol and the exact location is either implicitly or explicitly indicated, or is otherwise specified in the system operation or is configured by higher layers. Upon successfully decoding the signal, the UE responds according to an indication provided by the signal.

For example, the term ‘indication’ can refer to indication by dynamic signaling (e.g., L1 control such as DCI or MAC CE signaling). In one example, an indication can be for an associated occasion(s) (e.g., an occasion or multiple occasions associated with the indication).

For example, the term ‘semi-static signaling’ can be used for configuration of channels or signals with periodic resources, for configuration of periodic reports. For example, configuration of Type-1 configured grant (CG) PUSCH or periodic CSI-RS or periodic CSI reports on PUCCH. The resources can become active after configuration.

For example, the term ‘dynamic signaling’ can be used for activation of semi-persistent channels or signal or the activation of semi-persistent reports. For example, configuration of Type-2 configured grant (CG) PUSCH or semi-persistent CSI-RS or semi-persistent CSI reports on PUCCH or PUSCH. The resources become active and are transmitted periodically after activation and until they are deactivated.

For example, dynamic signaling can be used for indication or triggering of aperiodic channels or signals or indication or triggering of aperiodic reports. The channel, signal or report can be transmitted/received once (e.g. one-shot) or N times (e.g., N-shots). For example, PUSCH scheduled by an UL grant in a DCI or aperiodic CSI-RS or aperiodic CSI reports on PUSCH.

For example, a list with N elements or entries can be denoted as L(i), where i can take N values, and L(i) can correspond to the element or entry associated with index i. In one example, i can take N arbitrary values. In one example, i=0, 1, . . . , N−1. In one example, i=1, 2, . . . , N. In one example, i is an identity of an element or entry in the list.

In the following, monitoring of a channel or signal corresponds to the operations of receiving the channel or signal and decoding to obtain information provided by the channel or signal. For example, a PDCCH monitoring occasion is a time period where the UE receives candidate PDCCHs and decodes for DCI that would be provided by the candidate PDCCHs.

In the following, unless otherwise explicitly noted, providing a parameter value by higher layers includes providing the parameter value by a system information block (SIB), such as a SIB1, or by a common RRC signaling, or by UE-specific RRC signaling, or by core network signaling between a UE and a network node.

In the following, the suffix ‘-rxx’ is used to denote a parameter that does not currently exist in specifications and can be introduced to support the disclosed functionalities, with ‘xx’ denoting a number of a 3GPP release for the introduction of the parameter, e.g., xx=21 for Rel-21, or xx=22 for Rel-22, etc.

For example, a time unit, for example, can be a symbol or a slot or a sub-frame or a frame. In one example, a time-unit can be multiple symbols, or multiple slots or multiple sub-frames or multiple frames. In one example, a time-unit can be a sub-slot (e.g., part of a slot). For example, a time-unit can be specified in units of time, e.g., microseconds, or milliseconds or seconds, etc.

For example, a frequency-unit can be a sub-carrier (SC) or a resource block (RB) or a sub-channel, wherein a sub-channel is a group of SCs or RBs, or a bandwidth part (BWP). In one example, a frequency-unit can be multiple sub-carriers, or multiple RBs or multiple sub-channels. For example, a frequency-unit can be a sub-RB (e.g., part of an RB). A frequency-unit can be specified in units of frequency, e.g., Hz, or kHz or MHz, etc.

For example, a measurement signal or a measurement resource may correspond to one or more of the following:
Aperiodic or semi-persistent or periodic CSI-RS for channel measurements.
Aperiodic or semi-persistent or periodic CSI-IM (channel state information-interference measurement) (or zero power (ZP) CSI-RS) for interference measurements.
Aperiodic or semi-persistent or periodic non-zero power (NZP) CSI-RS for interference measurements.
On-demand (OD) signal for synchronization, e.g., OD-SS/PBCH Block (OD-SSB), or OD-SS, wherein OD-SS includes PSS and/or SSS or OD-low-power (LP)-SS. The OD signal for synchronization can be transmitted one or more times, or activated by a first signal/channel and transmitted periodically until it is deactivated by a second signal/channel, subject to processing latency.
Always-on (AO) signal for synchronization, e.g., AO-SS/PBCH Block (AO-SSB), or AO-SS, wherein AO-SS includes PSS and/or SSS or AO-LP-SS. The AO signal for synchronization can be configured by higher layer to be a periodic signal or a periodic burst of signals.

For example, uplink control information (UCI) may correspond to one or more of the following such as defined in REF3 with other or additional types of UCI not precluded:
Hybrid automatic repeat request acknowledgment (HARQ-ACK) for DL transport blocks or PDCCH transmissions without PDSCH.
Scheduling request (SR).
Channel state information (CSI) reports. For example, a CSI report can be a single part CSI report. In another example, a CSI report can be a two-part CSI report, e.g., a first part CSI report and a second part CSI report.
Link recovery request (LRR), this can be similar to SR.
UE initiated report indicator (UEIRI).

In the following, for brevity of description, the higher layer provided TDD UL-DL frame configuration can refer to tdd-UL-DL-ConfigurationCommon as example for RRC common configuration and/or tdd-UL-DL-ConfigurationDedicated as example for UE-specific configuration. For example, when using 5G/NR, the UE may determine a common TDD UL-DL frame configuration of a serving cell by receiving a SIB such as a SIB1 when accessing the cell from RRC_IDLE or by RRC signaling when the UE is configured with an SCell or additional SCGs by an IE ServingCellConfigCommon in RRC_CONNECTED. For example, the UE may determine a dedicated TDD UL-DL frame configuration using the IE ServingCellConfig when the UE is configured with a serving cell, e.g., add or modify, where the serving cell may be the SpCell or an SCell of an MCG or SCG. For example, a TDD UL-DL frame configuration may designate a slot or symbol as one of types ‘D’, ‘U’ or ‘F’ using a time-domain pattern with configurable periodicity.

Terminology such as TCI, TCI states, SpatialRelationInfo, target RS, reference RS, and other terms is used for illustrative purposes and is therefore not normative. Other terms that refer to same functions can also be used. A “reference RS” corresponds to a set of characteristics of a DL RX beam or an UL TX beam, such as a direction, a precoding/beamforming, a number of ports, and so on. A beam may also be referred to as spatial filter or spatial setting and be associated with a TCI state for quasi co-location (QCL) properties.

In certain embodiments, a TCI state may be used for beam indication. A TCI state may refer to a DL TCI state for DL channels, e.g. PDCCH or PD SCH, an UL TCI state for UL channels, e.g. PUSCH or PUCCH, a joint TCI state for DL and UL channels, or separate TCI states for UL and DL channels or signals. A TCI state may be common across multiple component carriers or may be a separate TCI state for a component carrier of a set of component carriers. A TCI state may be BS or UE panel specific or common across panels. In some examples, an UL TCI state may be replaced by an SRS resource indicator (SRI).

In certain embodiments, a cell may include or consist of more than one transmission/reception point (TRP). For example, mTRP operation may be referred to as intra-cell mTRP operation. In one example, a TRP may be identified by a CORESETPoolIndex associated with CORESETs for PDCCH receptions. In one example, a TRP may be identified by a group (e.g., one or more) SS/PBCH blocks (SSBs). For example, a first group or set of SSBs belong to or determine or identify a first TRP, a second group or set of SSBs belong to or determine or identify a second TRP, and so on. In one example, a TRP may be identified by a group (e.g., one or more) channel state information reference signal (CSI-RS) resources or CSI-RS resource sets. For example, a first group or set of CSI-RS resources or CSI-RS resource sets belong to or determine or identify a first TRP, a second group or set of CSI-RS resources or CSI-RS resource sets belong to determine or identify a second TRP, and so on. In one example, a TRP may be identified by a group (e.g., one or more) antenna ports. For example, a first group or set of antenna ports belong to or determine or identify a first TRP, a second group or set of antenna ports belong to determine or identify a second TRP, and so on. In one example, a TRP is identified or determined following one or more of the previous examples. In one example, a TRP may be identified by a group (e.g., one or more) sounding reference signal (SRS) resources or SRS resource sets. For example, a first group or set of SRS resources or SRS resource sets belong to or determine or identify a first TRP, a second group or set of SRS resources or SRS resource sets belong to or determine or identify a second TRP, and so on. In one example, a TRP may be identified by a group (e.g., one or more) TCI states (UL TCI states or DL TCI states or Joint TCI states or TCI state codepoints). For example, a first group or set of TCI states belong to or determine or identify a first TRP, a second group or set of TCI states belong to or determine or identify a second TRP, and so on.

In certain embodiments, the term “FR1” or a frequency range designation “FR1” may refer to a corresponding frequency range 410-7125 MHz; the term “FR2-1” or a frequency range designation “FR2-1” may refer to a corresponding frequency range 24250-52600 MHz; the term “FR2-2” or a frequency range designation “FR2-2” may refer to a corresponding frequency range 52600-71000 MHz; the term “FR2” or a frequency-range designation “FR2” may refer to FR2-1 or FR2-2.

In certain embodiments, the term “FR3” or a frequency range designation “FR3” may refer to a corresponding frequency range 7125-24250 MHz, or parts thereof. For example, an FR3 band may correspond to 7125-8400 MHz, or parts thereof, in ITU Region 2 or ITU Region 3. For example, an FR3 band may correspond to 7125-7250 MHz or 7750-8400 MHz, or parts thereof, in ITU Region 1. For example, an FR3 band may correspond to 14800-15350 MHz, or parts thereof, in an ITU Region. For example, for simplicity and illustration purposes, the term “FR3 7-8 GHz” may be used to refer to 6G radio access on a carrier or in a band of a frequency range such as 7125-8400 MHz, or the term “FR3 14-15 GHz” may be used to refer to 6G radio access on a carrier or in a band of a frequency range such as 14800-15350 MHz. The term “FR3 7-8 GHz” may be used interchangeably with a term such as “FR3 band 7-8 GHz” or “6G band 7-8 GHz”.

In certain embodiments, 6G radio access may be supported on a carrier or in a band of a frequency range such as FR1 corresponding to 4400-4800 MHz, or in a carrier or in a band corresponding to an FR1 or an FR2 operating band as defined in REF 7. For example, the term “FR1 4 GHz” may be used interchangeably with a term such as “FR1 band 4 GHz” or “6G band 4 GHz”.

In certain embodiments, 5G/NR radio access (or 4G/LTE) may be supported on a carrier or in a band of a frequency range corresponding to an FR1 or an FR2 operating band as defined in REF 7 for the case of 5G/NR.

In certain embodiments, a UE supporting 6G radio access may operate in single RAT mode or may operate in dual RAT mode.

For example, when operating in single RAT mode, the UE may select one RAT, e.g., one of 4G/LTE or 5G/NR or 6G radio access to (re-)select and camp on a serving cell in a band when in RRC_IDLE or RRC_INACTIVE state. For example, when operating in single RAT mode, the UE may be indicted one or more serving cells corresponding to one RAT in one or more bands by the network using mobility or handover procedures when in RRC_CONNECTED state. For example, a UE supporting 6G radio access and operating in single RAT mode may also support 4G/LTE or 5G/NR radio access, or may also support other wireless radio access such as Wi-Fi or Bluetooth or UWB.

For example, a dual RAT mode may be based on carrier aggregation operation, or dual connectivity operation or dual active protocol stack operation. For example, when operating in dual RAT mode, a multiple Rx and/or multiple Tx capable UE may be concurrently or simultaneously active on two serving cells using a separate RAT for each serving cell, respectively, wherein a first RAT may correspond to 6G radio access, and a second RAT may correspond to 5G/NR radio access or to 4G/LTE radio access. For example, when operating in dual RAT mode, the UE may be indicated with a first cell group comprising one or more serving cells corresponding to the first RAT, and a second cell group comprising one or more serving cells corresponding to the second RAT. For example, the first cell group may correspond to an MCG, and the second cell group may correspond to an SCG with reference to carrier aggregation or dual connectivity. Serving cells or cell groups may be located in a same or in different bands. For example, a UE supporting 6G radio access and operating in dual RAT mode may also support 4G/LTE or 5G/NR radio access, or may also support other wireless radio access.

For example, when operating in dual RAT mode based on principles such as described in REF 11 for multi-RAT dual-connectivity operation for scenarios such as LTE-NR or NR-LTE or NR-NR, a UE supporting 6G radio access may be configured to utilize radio resources provided by two different nodes connected via non-ideal or ideal backhaul, one node providing 6G radio access and the other node providing either 4G/LTE or 5G/NR radio access. One node may act as a master node (MN) and the other as secondary node (SN), where the MN and SN are connected via a network interface and at least the MN is connected to the core network. Transmissions to the UE or receptions from the UE using 4G/LTE or 5G/NR radio access may then occur on a primary cell group (PCG), and transmissions to the UE or receptions from the UE using 6G radio access may then occur on a secondary cell group (SCG). In another example, 6G radio access may occur on the PCG and 4G/LTE or 5G/NR radio access may occur on the SCG. For example, when operating in dual RAT mode based on carrier aggregation, if supported by 6G radio access, the UE supporting 6G radio access may be scheduled per cell group and network-side scheduling between the first and the second cell group, respectively, may or may not be coordinated between the cell groups.

For example, when operating in dual RAT mode based on dual active protocol stack operation, the UE supporting 6G radio access may be connected to a 6G serving cell in a first band while being connected to a 4G/LTE or 5G/NR cell in a second band. In one example, a dual-active protocol stack UE maintains separate RRC states with respect to the radio access network, i.e., a first RRC state corresponding to the 6G radio access and a second RRC state corresponding to the 5G/NR or the 4G/LTE radio access. In one example, a dual-active protocol stack LE may maintain a same or separate mobility or connection states with respect to the core network, i.e., a first mobility or connection management state corresponding to the 6G radio access and a second mobility or connection state corresponding to the 5G/NR or the 4G/LTE radio access.

In certain embodiments, a LUE supporting 6G radio access may transmit or receive on a carrier or in a band of a band combination according to carrier aggregation operation, or according to dual connectivity operation, or according to dual active protocol stack operation. Without loss of generality and for conciseness of description, the term “band combination” may refer to a band combination such as defined with respect to a carrier-aggregation band combination, or such as a dual connectivity band combination, or such as a dual active protocol stack band combination. For example, a UE supporting 6G radio access may operate in FDD mode or in TDD mode on a carrier or in a band. For example, the UE supporting 6G radio access may operate in a combination of FDD and/or TDD modes in a band or in a band combination.

In certain embodiments, the UE supporting 6G radio access may transmit or receive on a carrier or in a band of a band combination according to carrier aggregation operation, or according to dual connectivity operation, or according to dual active protocol stack operation using a single UL carrier, or using two or more UL contiguous or non-contiguous carriers. For example, based on single UL carrier operation, the UE supporting 6G radio access may transmit an UL signal or channel in a first UL carrier corresponding to 6G radio access or may transmit an UL signal or channel in a second UL carrier corresponding to 5G/NR radio access but the UL transmissions on the first and the second UL carrier then may occur separately in time-domain, e.g., in different slots or symbols, respectively, and the UE may switch between UL transmissions in the first and the second UL carrier, respectively. For example, the UE supporting 6G radio access may be capable of simultaneous UL transmission in two or more UL carriers in a same band or in different bands of a band combination. For example, a UE supporting 6G radio access using a single carrier or using two or more UL carriers may support a switching or a simultaneous UL transmission capability with respect to some or all UL signals or channel types. For example, the UE may support switching with respect to an UL signal of type SRS. For example, the UE may support simultaneous UL transmission capability with respect to an UL channel of type PUSCH on two or more UL carriers.

In certain embodiments, a UE supporting 6G radio access may operate according to a 6G reduced complexity (or reduced capability) (RC) feature. For example, the RC UE may support an internet of things (IoT) use case or may support an implementation according to a reduced complexity type of UE features or a minimum mandatory set of UE capability features; for example in order to lower the device cost, or to increase the achievable battery life or standby time, or to support a small form factor, or for deployment in certain deployment conditions when compared to a normal or a high-end device type such as using a smartphone form factor.

For example, the UE supporting 6G radio access according to the 6G RC feature (or 6G RC UE) may target DL data rates from several kbps to around several Mbps for use cases such as IoT or from around several Mbps to around 100 Mbps for reduced complexity UE implementation. For example, the 6G RC UE may support an UL or DL minimum coupling loss (MCL) of up to around 155 dB through a moderate number of repetitions, i.e., up to 32. For example, the 6G RC UE may support a standby time of up to several weeks or months for use cases such as IoT or a RC UE implementation.

For example, the 6G RC UE may operate in FR1 bands such as below 3 GHz for use cases such as IoT, or in FR1 or FR3 bands for reduced complexity UE implementations. For example, the 6G RC UE may operate based on 15 or 30 kHz SCS in FR1 or FR3. For example, the 6G RC UE may operate based on 120 or 240 kHz SCS in FR2.

For example, the UE supporting 6G radio access according to a 6G RC feature (or 6G RC UE) may implement one or more of a cost reduction technique when compared to other device types. For example, the 6G RC UE may operate according to a limited or restricted maximum RF bandwidth such as 3 or 5 MHz for a use case such as IoT or such as 20 MHz for a reduced complexity UE implementation. For example, the limited or restricted RF bandwidth may correspond to a maximum UE channel bandwidth BW_{UE,channel,max}. For example, the 6G RC UE may operate according to a limited or restricted maximum BB processing capability such as a maximum of 25 PRBs within a limited or restricted maximum RF bandwidth for reduced complexity UE implementation. For example, the 6G RC UE may operate according to a limited or restricted maximum RF bandwidth such as 20 MHz in the DL, or a limited or restricted BB processing capability such as 5 MHz or 25 PRBs within the restricted maximum RF bandwidth in the DL, or may operate according to a limited or restricted maximum RF bandwidth such as 5 MHz in the UL. For example, the 6G RC UE may operate according to FDD full-duplex mode, FDD half-duplex Type A or B modes, or according to TDD mode. For example, the 6G RC UE may perform DL receptions in a carrier or in a band based on 1 Rx antenna (or panel), or 2 Rx antennas (or panels), or more than 2 Rx antennas (or panels), or may implement limited or restricted support (including none) for a CSI-RS resource configuration, CSI reporting or MIMO operational capabilities. For example, the 6G RC UE may operate UL transmissions based on 1 Tx antenna (or panel). For example, the 6G RC UE may operate according to a PSM or a Cellular Internet of things (CIoT) feature. For example, the 6G RC UE may not support CA, or DC, or dual-protocol stack operation, i.e., and operate in single RAT mode. For example, the 6G RC UE may support to a limited or restricted maximum TB size, or support a limited or restricted set of modulation orders, or support a limited or restricted set of modulation-and-coding schemes when compared to other devices.

In certain embodiments, a UE may support a limited or restricted maximum UE channel bandwidth BW_{UE,channel,max} within a same spectrum for transmitting to or receiving from the BS. A UE channel bandwidth may be associated with a maximum transmission bandwidth configuration N_{RB} for a subcarrier spacing. For example, the UE channel bandwidth may support a single RF carrier in the UL or the DL at the UE. From a BS perspective, different UE channel bandwidths may be supported within the same spectrum for transmitting to and receiving from UEs connected to the BS. From a UE perspective, the UE may be configured with one or more BWPs in a carrier. The UE may not be aware of the BS channel bandwidth BW_{BS,channel} or how the BS allocates bandwidth to different UEs.

For example, when operating in an FDD band such as n66 (UL: 1710-1780 MHz, DL: 2110-2200 MHz), a set of UE channel bandwidth may correspond to BW_{UE,channel,n66}={5, 10, 15, 20, 25, 30, 35, 40} MHz for SCS=15 kHz. A normal or high-end UE may implement or be required to support some or all of UE channel bandwidths in the set BW_{UE,channel,n66} and support the maximum UE channel bandwidth 40 MHz for this band. A reduced complexity UE supporting up to a maximum UE channel bandwidth BW_{UE,channel,max}=20 MHz may implement and operate to a limited or a restricted channelization from the set {5, 10, 15, 20} MHz in this band.

For example, when operating in a TDD band such as n41 (UL/UL: 2496-2690 MHz), a set of UE channel bandwidth may correspond to BW_{UE,channel,n41}={10, 15, 20, 25, 30, 35, 40, 45, 50, 60, 70, 80, 90, 100} MHz for SCS=30 kHz. A normal or high-end UE may implement or be required to support some or all of UE channel bandwidths in the set BW_{UE,channel,n41} and support the maximum UE channel bandwidth 100 MHz for this band. A reduced complexity UE supporting up to a maximum UE channel bandwidth BW_{UE,channel,max}=20 MHz may implement and operate to a limited or a restricted channelization from the set {10, 15, 20} MHz in this band.

For example, when operating in an FDD band such as n5 (UL: 824-849 MHz, DL: 869-894 MHz), a set of UE channel bandwidth may correspond to BW_{UE,channel,n5}={5, 10, 15, 20} MHz for SCS=15 kHz. A normal or high-end UE may implement or be required to support some or all of UE channel bandwidths in the set BW_{UE,channel,n5} and support the maximum UE channel bandwidth 20 MHz in this band. A reduced complexity UE supporting up to a maximum UE channel bandwidth BW_{UE,channel,max}=5 MHz may implement and operate to a limited or a restricted channelization from the set {5} MHz in this band.

For example, a maximum transmission bandwidth configuration N_{RB} for a subcarrier spacing 15 kHz may correspond to 15 or 12 RBs for a UE channel bandwidth of 3 MHz, or to 25 or 20 RBs for a UE channel bandwidth of 5 MHz, or to 106 RBs for a UE channel bandwidth of 20 MHz using 15 kHz SCS, or to 51 RBs for a UE channel bandwidth of 20 MHz using 30 kHz SCS when operating in FR1.

In certain embodiments, a UE supporting a reduced complexity or reduced capability feature is provided with information associated with operation in bandwidth parts (BWPs).

For example, the UE is provided with a set of BWPs for receptions by the UE in a DL carrier bandwidth, i.e., a DL BWP set, or a set of BWPs for transmissions by the UE in an UL carrier bandwidth, i.e., an UL BWP set. For example, a frequency-domain occupancy of a BWP may be defined by a common RB N_{BWP}^{start}=O_{carrier}+RBₛₜₐᵣₜ and a number of contiguous RBs N_{BWP}^{size}=L_{RB} provided by parameter locationAndBandwidth that indicates an offset RBₛₜₐᵣₜ and a length L_{RB} as RIV according to [REF 4], by setting N_{BWP}^{size}=275, and a value O_{carrier} provided by parameter offsetToCarrier for the subcarrierSpacing.

For example, the UE receives or transmits in an active BWP from a set of configured BWPs N_{BWP}. For example, a size of N_{BWP}=2 or 4. For example, DL receptions or UL transmissions by the UE are limited or restricted to within the active BWP. For example, the UE does not receive a DL signal/channel or does not transmit an UL signal/channel outside its active BWP, except possibly for specific purposes such as an SRS transmission or a CSI-RS reception for positioning or a CSI estimation. The UE may determine an initial or default BWP under certain system operating conditions. For example, a set of DL and of UL BWPs, may be separately provided for DL receptions and UL transmissions, respectively. For unpaired spectrum operation, a DL BWP may be associated or linked with an UL BWP, and the UE does not expect to receive a configuration wherein the center frequency for the DL BWP is different than the center frequency for the UL BWP. For example, the BS may configure a same set of BWPs for different UEs or may configure different sets for different UEs. For example, the UE may support fast BWP switching, e.g., <140 us, under certain system operation conditions. For example, to support fast BWP switching, the UE may apply a same SCS or apply a same BWP size or apply a same set of higher layer protocol parameters when switching the active BWP to another BWP in the set of configured BWPs. For example, the UE may be provided with a first set of BWPs having same aforementioned parameters, and may be provided with a second set of BWPs having same aforementioned parameters that are different from the ones of BWPs in the first set of BWPs, thereby enabling fast switching among BWPs within the first set of BWPs or within the second set of BWPs, and slower switching among BWPs in different sets of BWPs while also allowing flexibility in changing the values of the aforementioned and of other parameters. In this manner, both fast BWP switching with restrictions in the BWP parameters and slow BWP switching without restrictions in the BWP parameters can be simultaneously supported.

For example, when the UE operates according to inter-slot frequency-hopping based on BWP operation, the UE switches the active BWP to one of the configured BWPs provided in the set N_{BWP}. For example, the UE may switch a BWP in a last or a first number of symbols of a slot. For example, the BWP switching or hopping pattern with respect to frequency domain or time-domains may be defined by rules such as provided in system specifications, or may be provided to the UE by higher layer parameters. For example, BWP switching or hopping across more than one BWP by the UE may occur according to information provided by higher layers or may be associated with the reception of a DCI, e.g., such as when receiving a bandwidth part indicator field in a DCI or upon reception of a frequency-domain resource allocation field in a DL assignment or in an UL grant.

In certain embodiments, a UE supporting a reduced complexity or reduced capability feature is provided with information associated with a subband configuration in a carrier bandwidth.

For example, the UE is configured by higher layers or indicated by the BS one or more subbands for receptions by the UE in a DL carrier bandwidth, i.e., a set of DL subbands, or a set of one or more subbands for transmissions by the UE in an UL carrier bandwidth, i.e., a set of UL subbands. For example, a frequency-domain occupancy of one or more subbands may be provided to the UE with respect to a carrier bandwidth or a maximum transmission bandwidth configuration N_{RB}, e.g., by associating a sequence of RBs with a first, or a second, or a third subband, etc., or in a well-defined order for the RBs in a carrier bandwidth according to system operating specifications. For example, a number of subbands in a carrier bandwidth may correspond to

$${N}_{S B} = ⌊ \frac{{N}_{R B}}{15} ⌋$$

for a limited bandwidth UE with BW_{UE,channel}=3 MHz and the subbands may be numbered N_{SB}=0, . . . , N_{NB}−1 in order of increasing PRB numbers. For example, a frequency-domain occupancy of a subband may be defined by a common RB N_{SB}^{start}=O_{carrier}+RBₛₜₐᵣₜ and a number of contiguous RBs N_{SB}^{size}=L_{RB} provided by parameter locationAndBandwidth that indicates an offset RBₛₜₐᵣₜ and a length L_{RB} as RIV according to [REF 6], by setting N_{SB}^{size}=275, and a value O_{carrier} provided by parameter offsetToCarrier for the subcarrierSpacing.

The UE may receive a DL signal or channel in a DL subband from a set of provided subbands N_{SB,DL}. The UE may transmit an UL signal or channel in an UL subband from a set of provided subbands N_{SB,UL}. For example, the size of N_{SB,DL}=2 or 4, or N_{SB,UL}=2 or 4. For example, a set of DL and of UL subbands, may be separately provided for DL receptions and UL transmissions, respectively. The UE may determine an initial or default subband under certain system operating conditions. For example, the BS may configure a same set of subbands for different UEs or may configure different sets of subbands for different UEs. For example, the UE may support fast subband switching, e.g., <140 us, under certain system operation conditions. For example, to support fast subband switching, the UE may apply a same SCS or apply a same subband size or apply a same set of higher layer protocol parameters when switching from a subband to another subband in the set of subbands.

For example, when the UE operates according to inter-slot frequency-hopping based on a subband in a carrier bandwidth, the UE may switch DL receptions from a first DL subband to a second DL subband in the set N_{SB,DL} according to system operation, or the UE may switch UL transmissions in a first UL subband to a second UL subband in the set N_{SB,UL} according to system operation conditions. For example, the subband switching or hopping pattern with respect to frequency domain or time-domain resources may be defined by rules such as provided in system specifications, or may be provided to the UE by higher layer parameters. For example, subband switching or hopping by the UE may occur according to information provided by higher layers or may be associated with the reception of a DCI, e.g., such as when receiving an indicator field in a DCI or upon reception of a frequency-domain resource allocation field in a DL assignment or in an UL grant.

In certain embodiments, a UE supporting a reduced complexity or reduced capability feature may operate based on a frequency hopping protocol in a set of BWPs or subbands in a carrier bandwidth.

For example, a first DL reception or UL transmission bandwidth of the UE in a symbol or slot may be limited or restricted. For example, the first DL reception or UL transmission bandwidth may be limited or restricted with respect to a size of a BWP, or a size of a subband, or a number of subcarriers, or a number or locations of RBs or of RBGs, or with respect to a maximum UE DL or UL channel bandwidth BW_{UE,channel,max}, or a maximum supported or indicated RF or BB bandwidth reception or transmission bandwidth of the UE. For example, the limited or restricted DL reception or UL transmission bandwidth of the UE may correspond to 3 MHz, or to 5 MHz, e.g., for a use case such as IoT, or may correspond to 20 MHz, e.g., for a UE supporting a reduced complexity implementation or reduced capability. A later second DL reception or UL transmission with the limited or restricted DL reception or UL transmission bandwidth may occur in another BWP or in another subband of a DL or UL carrier bandwidth or of a larger BS DL or UL channel bandwidth BW_{BS,channel}. For example, in cases such as a PDCCH, or a PDSCH, or a CSI-RS reception, or in cases such as a PUSCH, or a PUCCH, or a PRACH, or an SRS transmission, or in cases such as a PDCCH, or a PDSCH, or a PUSCH, or a PRACH, or an SRS repetition, or in cases such as a PDSCH or a PUSCH multi-slot scheduling, or in cases such as a reception or transmission of a PDSCH or a PUSCH according to TBoMS operation, frequency hopping in blocks of Nₕₒₚ symbols or slots may be applied for DL receptions or UL transmissions by the UE. For example, the frequency hopping may occur across different BWPs or across different subbands within the carrier bandwidth or the BS channel bandwidth. For example, the frequency hopping may occur across different symbols or slots.

For example, the UE may not expect to be provided with a BWP or subband configuration wherein one or more RBs can overlap between a first and second BWP or subband. For example, the UE may not expect to be provided with a set of BWPs or a set of subbands wherein a BWP or subband i is separated by fewer than a threshold X of RBs or RBGs from a BWP or subband j in the set to provide a minimum frequency separation for hopping across BWPs or subbands. For example, the UE may not expect to be provided with a set of BWPs or a set of subbands wherein a BWP or subband i is separated by more than a threshold Y of RBs or RBGs from a BWP or subband j in the set to provide a maximum frequency separation or maximum hopping width across the set BWPs or subbands or the carrier bandwidth.

A set of BWPs N_{BWP} or of subbands N_{SB} may be provided to the UE. For example, N_{BWP} may be provided as N_{BWP}=4. A parameter Fₕₒₚ associated with a subset or a number of BWPs or of subbands which are available for hopping in frequency-domain may be provided to the UE. For example, a size of Fₕₒₚ≤N_{BWP} or Fₕₒₚ≤N_{SB}. The UE may hop across BWPs or subbands based on a subset from the set of the provided BWPs or subbands including all of the BWPs or subbands. For example, a parameter Nₕₒₚ corresponding to a number of slots with a transmission or reception in a same BWP or subband may be provided to the UE. For example, Nₕₒₚ=1, and frequency hopping occurs in every slot, or Nₕₒₚ=4, and frequency hopping occurs every four slots. Other suitably selected time units such as a number of symbols or of subframes may be applied when describing a frequency hopping behavior. For example, the BWPs or the subbands in the carrier BW across which a hopping pattern is defined may be equally or unequally spaced in frequency-domain, or hopping in frequency-domain may use only some or all of the configured BWPs or subbands. For example, separate values corresponding to a frequency hopping parameter may be provided to the UE for the DL receptions and UL transmissions, respectively.

For example, in order to align the frequency hopping behavior between different transmissions from UEs and ensure that the UEs “hop” at the same time instant, the hopping instants may not be UE specific, and may be defined cell-common for the frequency-hopping UEs within a cell. For example, the hopping instants may be defined or selected with respect to the SFN and/or may be counted from the first slot in a frame with SFN=0 such that the hopping takes place between slot k*Nₕₒₚ−1 and slot k*Nₕₒₚ for the frequency-hopping transmissions regardless of the start of the transmission from the UE perspective. For example, a frequency-hopping block length Nₕₒₚ, or a hopping distance or hopping offset in frequency domain, or a set Fₕₒₚ associated with a set of BWPs or of subbands available for hopping may be provided to the UE using higher layer signaling such as cell-specific or UE dedicated signaling.

In certain embodiments, a UE is provided with information associated with an operation based on a virtual or reference BWP in a carrier bandwidth to determine a frequency-domain allocation of a DL or UL signal or channel or to determine whether a transmission or a reception in a BWP or subband corresponding to a reduced bandwidth transmission or reception in a carrier bandwidth is allowed or dis-allowed, or enabled or disabled, or to determine a transmission or a reception parameter corresponding to a reduced bandwidth transmission or reception in a carrier bandwidth.

For example, the virtual or reference BWP may correspond to a frequency-domain occupancy larger than a maximum supported RF bandwidth for transmission or reception by a RC UE or smaller than a maximum supported UE channel BW in a band. For example, the virtual or a reference BWP may correspond to a supported RF bandwidth or a supported UE channel BW for transmission or reception by a RC UE in a band, and reduced bandwidth transmission or reception in a carrier bandwidth is allowed or dis-allowed, or enabled or disabled, as a processing restriction with respect to a maximum number of RBs, or RBGs, or SCs for a DL or UL signal or channel within the bandwidth of the virtual or a reference BWP. In one example, the reference BWP may correspond to 20 MHz, i.e., a maximum supported RF bandwidth for receptions by the RC UE, and the maximum number of RBs of the processing restriction within the 20 MHz of the reference BWP may correspond to 25 RBs for an SCS=15 kHz. For example, the virtual or reference BWP may correspond to a non-contiguous resource allocation in frequency-domain with respect to a common resource grid such as provided by the CRB grid.

For example, the virtual or reference BWP may be associated with a frequency-domain resource allocation such as a number of RBs or a reference RB numbering corresponding to a range larger than a restricted or limited maximum reception or transmission bandwidth of the UE in a symbol or slot. For example, the virtual or reference BWP may comprise one or more BWPs or subbands provided to the UE for frequency-hopping in a carrier bandwidth. For example, the UE is provided with information for a virtual or a reference BWP to determine a frequency-domain occupancy of a DL subband, or of an UL subband, or for a reception or a transmission bandwidth, or a set or a size or a number of subbands, or a size of an RBG or a set of RBG sizes, or a bundling size such as a PRG bundling size, or a sub-carrier spacing. For example, the UE may operate according to a frequency hopping protocol based on a reference or a virtual BWP in a carrier bandwidth.

For example, a virtual or a reference BWP may be provided as information to a UE, i.e., a reference BWP of a UE can be configured, or indicated, or assigned to the UE, or can be tabulated by system operating specifications. A virtual or reference BWP may be determined by the UE. For example, a reference BWP may correspond to an actual BWP, i.e., one from a set of configured BWPs for UE receptions in a DL bandwidth, or one from a set of configured BWPs for UE transmissions in an UL bandwidth. For example, the UE can determine an active BWP of a serving cell to be a reference BWP. For example, a reference BWP may be selected by the UE from a set of configured BWPs. A reference BWP may correspond to an assumed or a virtual BWP configuration for which a parameter is provided to the UE. Based on the parameter the UE further determines a reception or transmission condition. For example, a virtual or a reference BWP may be determined by the UE based on a slot or symbol type based on a condition such as a condition corresponding to a transmission direction, i.e., DL or UL or Flexible, or NES or non-NES, or simultaneous Tx-Rx/SBFD or no simultaneous Tx-Rx/non-SBFD. A reference BWP for UE determination of a frequency-domain occupancy of DL subband, or of an UL subband or a guard band in the reception or transmission bandwidth may be provided to the UE or may be determined by the UE for a secondary cell or a secondary cell group, e.g., such as when operation according to reduced complexity or reduced capability is configured as SCell. For example, a virtual or reference BWP may be provided to the UE using a signaling described for UE operation in bandwidth parts (BWPs) such as indicating a common RB N_{BWP,ref}^{start}=O_{carrier}+RB_{start,ref} and a number of contiguous RBs N_{BWP,ref}^{size}=L_{RB,ref} with respect to a common RB grid.

For example, a frequency hopping operation on RBs or RBG or subbands may be defined based on a reference or virtual BWP. A reference or virtual BWP N_{BWP,ref} may be provided to the UE. A first set and a second set of RBs or RBGs or a first and a second subband S₁ and S₂ of the reference BWP N_{BWP,ref} which are available for hopping in frequency-domain may be provided to the UE. For example, a set S₁ and S₂ of RBs or RBGs or a first and a second subband of the reference BWP may be determined by the UE based on a frequency hopping parameter such as a number of hops or a hopping distance. The UE may hop across the set S₁ or S₂ of RBs or RBGs or the first and the second subband based on a subset from the set of RBs or RBGs or set of subbands in a reference or virtual BWP. For example, the RBs or RBGs or the subbands in the reference BWP across which a hopping pattern is determined may be evenly or unevenly spaced, i.e., separated in frequency-domain, or may have a same size or different sizes in frequency-domain. For example, separate values corresponding to a frequency hopping parameter may be provided to the UE for the DL receptions and UL transmissions, respectively.

Rel-18 and Rel-19 NR supports a network energy savings (NES) feature such as Cell DTX/DRX operation, SSB-less SCell operation for inter-band CA, CSI enhancements for adaptations in spatial and power domains, or higher layer enhancements according to Rel-18 NR, or such as configuration or adaptation of common signals or channels, or on-demand SIB1 PCell operation for UEs in RRC_IDLE/INACTIVE modes, or on-demand SSB SCell operation according to Rel-19 NR.

Using Cell DTX/DRX operation according to Rel-18 NR, a periodic cell-specific DTX/DRX pattern can be provided to the UE. The cell-specific DTX/DRX pattern identifies the active and non-active periods of the BS. No transmission or reception occurs for some predetermined signals during the non-active period of the cell-specific DTX/DRX pattern. A DTX pattern with respect to DL transmissions from the BS or a DRX pattern with respect to the UL transmissions to the BS can be configured and/or activated separately or jointly. A maximum of 2 cell-specific DTX/DRX patterns per MAC entity can be provided for different serving cells. Cell DTX/DRX operation is supported for UEs in RRC_CONNECTED mode when the UE C-DRX functionality is also configured. Cell DTX/DRX operation can be (de-)activated by RRC signaling or by a DCI format 2_9. For example, random access, SSB reception, SI broadcast, or paging are not assumed impacted. The UE C-DRX operation in RRC_CONNECTED mode is controlled by the BS, and it is assumed that the BS coordinates the periodicity and the on-duration of the cell DTX/DRX pattern with respect to the on-durations corresponding to the UE C-DRX short or long cycles.

Using SSB-less SCell operation for inter-band CA according to Rel-18 NR, an SSB-less SCell can be activated by relying on a reference inter-band cell in the case of FR1 and a co-located deployment. New SCell activation requirements based on aperiodic or periodic TRS are introduced for the SSB-less SCell, i.e., subject to MRTD, EPRE, QCL conditions.

Using CSI enhancements for adaptations in spatial and power domains according to Rel-18 NR, a new CSI reporting framework with N>=1 CSI sub-report(s) in one reporting instance is supported. For example, L>=N sub-configurations per CSI report setting can be provided to the UE wherein each sub-configuration can correspond to a set of spatial-domain (SD) and/or power-domain (PD) parameters. For Type 1 SD, a reduced number of antenna ports based on a common CSI-RS resource can be configured. For Type 2 SD, a reduced number of AEs and/or antenna ports (APs) without reducing the number of APs can be configured. The UE can derive a CSI report according to the CSI sub-configurations and map the CSI sub-reports in a same CSI report wherein occupied CPU and/or process counting is based on the active CSI-RS resources/ports per CSI sub-configuration.

Using higher layer enhancements according to Rel-18 NR, a new barring bit is specified in SIB1 to allow access to the serving cell only for UEs supporting the Cell DTX/DRX functionality. Furthermore, a number of NES-specific CHO events are defined and DCI based notification is supported to indicate execution/entry conditions. For example, a coverage cell may request a capacity booster cell to switch on some SSB beams using network internal signaling. Paging of UEs in RRC_INACTIVE may be based on a limited SSB set with a recommended SSB list in the PCH.

Using configuration or adaptation of common signals or channels according to Rel-19 NR, SSB periodicities, or PRACH transmission opportunities can be adjusted according to the NES state of the cell. For example, SSB adaptation based on BS proprietary implementation is supported wherein the BS can adjust an SSB periodicity in the DL using one of the legacy SSB burst periodicity values. SSB adaptation is not supported for an SSB on the PCell sync raster in any RRC mode. PRACH adaptation in time-domain is supported for all RRC modes and is based on an additional provided RACH configuration. A DCI-based adaptation for additional PRACH resources in a DCI format 1_0 with P-RNTI using 1 bit is supported.

Using on-demand SIB1 PCell for UEs in RRC_IDLE/INACTIVE modes according to Rel-19 NR, the UE obtains an UL Wake-up signal (WUS) configuration from a non-NES cell, then transmits the UL WUS and receives an on-demand (OD) SIB1 on the NES cell. For example, the UE can determine the support for on-demand SIB1 in a cell based on the UL WUS configuration from the non-NES cell. The UL WUS corresponds to a PRACH with a dedicated preamble. Based on the BS implementation, the PRACH which is provided as UL WUS resource may correspond to a shared RO or to separate ROs. The UL WUS configuration may include other parameters such as an RSRP threshold, a Msg.1 subcarrier spacing, a search space set configuration for scheduling a response to the UL WUS transmission, or a TA offset value. The spatial relations for the PDCCH/PDSCH of the on-demand SIB1, the SSB, and the UL WUS follows principles of legacy Rel-15 NR. The UL transmit power control or UE power ramping behavior for UL WUS transmissions, i.e., PRACH, follows the principles of legacy Rel-15 NR. A Type0-PDCCH monitoring occasion can be provided by the UL WUS configuration from the SSB on the sync raster in the NES cell. The CORESET0 of the NES cell is used as the CORESET for the scheduling of the response to the UL WUS transmission. A duration of the on-demand SIB1 is based on a window and can be indicated by the UL WUS configuration.

Using on-demand SSB SCell operation according to Rel-19 NR, a transmission of on-demand SSB on an SCell can occur in presence or absence of always-on SSBs. An on-demand SSB periodicity may correspond to a legacy SSB periodicity value, i.e., in a range of 5 to 160 ms for a certain specified set of values. For example, a value for the on-demand SSB periodicity may be separate and less than a value for the always-on SSB periodicity. The UE may assume a same QCL per corresponding SSB index assumed for the on-demand and always-on SSBs. A transmission of on-demand SSB on the SCell is triggered by the BS. An on-demand SSB doesn't need to be located on the sync raster and may correspond to an NCD-SSB. L1 based and/or L3 measurements are supported using the on-demand SSBs on the SCell. On-demand SSBs can be configured and/or indicated based on RRC signaling and/or MAC-CE based de-activation/indication.

Using Rel-18 NR, DCI format 2_9 can be used for activating or de-activating the cell DTX and/or DRX configuration of one or multiple serving cells for one or more UEs, and/or for providing NES-mode indication of the primary cell for one or more UEs. The following information is transmitted by means of the DCI format 2_9 with CRC scrambled by cellDTRX-RNTI: block number 1, block number 2, . . . , block number N, where the starting position of a block associated with a serving cell is determined by the parameter positionInDCI-cellDTRX provided by higher layers for the UE. The size of DCI format 2_9 is indicated by the higher layer parameter sizeDCI-2-9. If search space set s is a CSS set, the UE may receive an indication by parameter dci-Format2-9 to monitor PDCCH candidates for DCI format 2_9. If the UE is configured to monitor DCI format 2_9, one or more blocks are configured for the UE by higher layers, with the following fields defined for each block.

A cell DTX/DRX indication with a number of bits can be determined by the following: if higher layer parameter cellDTX-DRX-L1activation is configured, 2 bits as defined in [REF 3] and if parameter cellDTX-DRX-ConfigType is configured to dtxdrx for the associated serving cell of the block, the MSB corresponds to cell DTX configuration and the LSB corresponding to cell DRX configuration; or 1 bit as defined in [REF 3] if parameter cellDTX-DRX-ConfigType is configured to either dtx or drx for the associated serving cell of the block; or 0 bit otherwise.

A NES-mode indication with 1 bit indicating NES-specific CHO execution condition as defined in [REF 3] if the higher layer parameter nesEvent is configured and the associated serving cell of the block is primary cell; or 0 bit otherwise.

With respect to detailed procedures for DCI format 2_9 reception, if a UE is configured for operation on a serving cell according to one or both of a cell DTX operation and a cell DRX operation by cellDTRX-DCI-Config for the serving cell as defined in [REF 5], the UE can be additionally provided by dci-Format2-9 a Type3-PDCCH CSS set to monitor PDCCH for detection of DCI format 2_9 during Active Time, and a location in DCI format 2_9 by positionInDCI-cellDTRX of a cell DTX/DRX indication field for the serving cell and/or a NES-mode indication field for the PCell.

If the UE is configured with both cell DTX operation and cell DRX operation for the serving cell and if cellDTX-DRX-L1activation is provided, the cell DTX/DRX indication field includes two bits where the first bit indicates the cell DTX operation and the second bit indicates the cell DRX operation.

If the UE is configured with only one of the cell DTX operation and cell DRX operation for the serving cell and if cellDTX-DRX-L1activation is provided, the cell DTX/DRX indication field includes one bit indicating one of the cell DTX operation and cell DRX operation, respectively, for the serving cell, wherein a ‘0’ value for a bit of the cell DTX/DRX indication field indicates deactivation of cell DTX or of cell DRX, a ‘1’ value for a bit of the cell DTX/DRX indication field indicates activation of cell DTX or of cell DRX. If the serving cell is configured with a SUL carrier, the cell DTX/DRX indication field indication for activation or deactivation of cell DRX applies to both the UL carrier and the SUL carrier.

If the UE is configured with nesEvent, the NES-mode indication field includes one bit indicating NES-specific CHO execution condition, as described in [REF 6], wherein a ‘0’ value for the NES-mode indication field indicates NES-specific CHO execution condition is disabled, and a ‘1’ value for the NES-mode indication field, indicates NES-specific CHO execution condition is enabled.

A UE does not expect to monitor PDCCH for detection of DCI format 2_9 on more than one serving cells of one cell group.

When a UE which is provided with cellSpecificKoffset receives in slot m on the active DL BWP of a serving cell a PDCCH providing DCI format 2_9 that indicates a change in activation or deactivation of a current cell DTX operation for the serving cell, the UE operates on the serving cell according to the indicated cell DTX operation starting from the first slot on the active DL BWP that does not begin before the beginning of the slot m+d on the active DL BWP of the serving cell, where d is a number of slots for the SCS of the active DL BWP of the serving cell in Table 1 below.

When a UE which is not provided with cellSpecificKoffset receives in slot m on the active DL BWP of a first serving cell a PDCCH providing DCI format 2_9 that indicates a change in activation or deactivation of a current cell DTX operation or cell DRX operation for a second serving cell, the UE operates on the second serving cell according to the indicated cell DTX operation or cell DRX operation starting from the first slot on the active DL BWP or on the active UL BWP of the second serving cell, respectively, that does not begin before the beginning of the slot m+d on the active DL BWP of the first serving cell where d is a number of slots for the SCS of the active DL BWP of the first serving cell shown in Table 1 as defined in [REF 3].

When a UE which is provided with cellSpecificKoffset receives in slot m on the active DL BWP of a serving cell a PDCCH providing DCI format 2_9 that indicates a change in activation or deactivation of a current cell DRX operation for the serving cell, the UE operates on the serving cell according to the indicated cell DRX operation starting from slot

$$⌊ ( m + d ) \cdot \frac{{2}^{{μ}_{UL}}}{{2}^{{μ}_{DL}}} ⌋ + {K}_{cell , offset} \cdot {2}^{{μ}_{UL}}$$

on the active UL BWP where d is a number of slots for the SCS of the active DL BWP of the cell in Table 1, K_{cell,offset} is the cellSpecificKoffset, μ_{DL} and μ_{UL} are the SCS configurations of the active DL BWP and the active UL BWP of the cell, respectively.

TABLE 1
Minimum time gap value d [REF 3]

| SCS (kHz) | Number of slots |
|---|---|
| 15 | 3 |
| 30 | 6 |
| 60 | 12 |
| 120 | 24 |
| 480 | 96 |
| 960 | 192 |

If cell DTX is activated for the serving cell, the UE is not expected to decode a PDSCH scheduled without corresponding PDCCH transmission using SPS-Config that overlap in time with any non-active periods of cell DTX for the serving cell. If more than one PDSCH on a serving cell each without a corresponding PDCCH transmission are in a slot, after resolving overlapping with symbols in the slot indicated as uplink by tdd-UL-DL-ConfigurationCommon, or by tdd-UL-DL-ConfigurationDedicated, or determined as non-active periods of cell DTX, if the serving cell is activated with cell DTX as defined in REF 5, a UE receives one or more PDSCHs without corresponding PDCCH transmissions in the slot as specified below.

During non-active periods of cell DTX if cell DTX is activated for a serving cell, the UE is not expected to receive the periodic CSI-RS and semi-persistent CSI-RS on the serving cell configured in CSI report configuration in CSI-ReportConfig associated with the higher layer parameter reportQuantity comprising at least ‘RI’. If the cell DTX is activated for a serving cell, the most recent CSI measurement occasion of semi-persistent CSI-RS resource or periodic CSI-RS resource on the serving cell occurs in active periods of cell DTX for CSI report configured by CSI-ReportConfig associated with the higher layer parameter reportQuantity comprising at least ‘RI’.

For the CSI report configuration in CSI-ReportConfig associated with the higher layer parameter reportQuantity comprising at least ‘RI’, the UE reports a CSI report only if receiving at least one CSI-RS transmission occasion of each periodic CSI-RS resource or semi-persistent CSI-RS resource on a serving cell with cell DTX activated for channel measurement and/or interference measurement in active periods of cell DTX of the serving cell no later than CSI reference resource, and the UE drops the CSI report otherwise.

If the higher layer parameter timeRestrictionForChannelMeasurements in CSI-ReportConfig is set to “Configured”, the UE can derive the channel measurements for computing CSI reported in uplink slot n based on only the most recent, no later than the CSI reference resource, in cell DTX active period of a serving cell if cell DTX is activated, occasion of NZP CSI-RS associated with the CSI resource setting on the serving cell.

If the higher layer parameter timeRestrictionForlnterferenceMeasurements is set to “notConfigured”, the UE can derive the interference measurements for computing CSI value reported in uplink slot n based on only the CSI-IM and/or NZP CSI-RS for interference measurement no later than the CSI reference resource associated with the CSI resource setting. If the higher layer parameter timeRestrictionForlnterferenceMeasurements in CSI-ReportConfig is set to “Configured”, the UE can derive the interference measurements for computing the CSI value reported in uplink slot n based on the most recent, no later than the CSI reference resource, in cell DTX active period of a serving cell if cell DTX is activated, occasion of CSI-IM and/or NZP CSI-RS for interference measurement associated with the CSI resource setting on the serving cell.

If cell DRX is activated for the serving cell, after resolving the overlapping for PUCCH and/or PUSCH transmissions, and a PUCCH or PUSCH transmission would overlap with the non-active period of cell DRX of the serving cell, the UE does not transmit the PUCCH if HARQ-ACK information is not multiplexed in the PUCCH, or does not transmit the PUSCH if HARQ-ACK information is not multiplexed in the PUSCH and the PUSCH is not associated with a corresponding PDCCH, respectively.

When implementing UE procedures with reduced capabilities, or for receiving control information, or for network-energy savings in a wireless communication system, several issues related to limitations and drawbacks of IoT or reduced complexity (RC) UEs need to be overcome in order to enable an effective use of a network energy savings (NES) feature such as BS transmission or reception bandwidth adaptation, or cell DTX/DRX operation, or dynamic cell on/off operation, or configuration or adaptation of common channels/signals in the deployment when IoT or RC UEs are operating in a cell.

For example, the UE supporting 6G radio access according to the 6G reduced capability (RC) feature (i.e., the 6G RC UE) may implement a cost reduction technique. For example, the 6G RC UE may operate according to a limited or restricted maximum RF bandwidth when compared to the 6G carrier BW, such as 5 MHz for use cases such as IoT or a maximum RF bandwidth such as 20 MHz for reduced complexity UE implementation. Without loss of generality and for illustration purposes, an exemplary maximum RF bandwidth of 5 MHz is assumed by some examples, but similar implementations can be extended to other maximum RF bandwidths such as 1.4 MHz or 3 MHz, or similar implementations can be extended to combinations of a maximum RF bandwidth such as 20 MHz in the DL and a limited or restricted maximum BB processing capability such as 5 MHz or 25 RBs in the DL within the maximum RF bandwidth or a maximum transport block size (TBS) limitation within the maximum RF bandwidth. For example, a maximum RF bandwidth in the DL such as 20 MHz may be supported by a RC UE in combination with a maximum RF bandwidth in the UL such as 5 MHz.

A first issue relates to BS bandwidth adaptation, i.e., a reduction in the BS transmission bandwidth or the BS channel bandwidth BW_{BS,channel} for network energy savings when operating in a network deployment where IoT or RC UEs may be present.

For example, a BS bandwidth adaption for NES may change or adjust a DL or UL carrier BW, or a DL or UL UE channel BW, or a DL or UL BS transmission BW according to system operation conditions. For example, a commercial BS side radio unit (RU) may support a large BS channel BW such as BW_{BS,channel}=160 MHz or 320 MHz. For example, using Rel-15 NR and operation in NR band n41 (2.6 GHz), a BS channel BW may then be reduced by indicating a smaller DL or UL carrier BW such as 20 MHz instead of 100 MHz for the serving cell in SIB1, and/or by configuring a smaller BWP within the carrier BW for the UE. A BS power consumption may then be accordingly reduced. For example, using Rel-15 NR, for a normal or high-end UE supporting up to the maximum nominal UE channel bandwidth in the operating band, the UE may then be provided with a BWP of an accordingly reduced size. A UE reception or transmission activity is then controlled by the BS due to the restriction in the existing state-of-the-art, that the Rel-15 NR UE doesn't receive or transmit outside its active BWP. However, for the UE supporting a limited or a restricted maximum UE channel bandwidth BW_{UE,channel,max} such as BW_{UE,channel,max}=3 or 5 MHz for IoT or BW_{UE,channel,max}=20 MHz for a RC UE implementation, to increase link robustness and load spreading across the carrier bandwidth, the effectively occupied bandwidth across slots within the carrier bandwidth may be larger than the limited or the restricted instantaneous transmission or reception bandwidth in a transmission or reception instance, e.g., when frequency-hopping across BWPs or subbands for such UEs is enabled. For example, using existing Rel-13 LTE for eMTC UEs, the BS may configure another DL or UL carrier BW using SIB1, or the BS may provide another set of frequency hopping parameters to the eMTC UE using RRC signaling. A shortcoming is then that the associated application delays may be high and the number of resulting signaling exchanges may be frequent. For example, LTE or NR UEs typically re-acquire a SIB1 infrequently, i.e., subject to certain conditions [REF 6]. It also needs to be considered that IoT or RC UEs can often require support for long battery life or standby times. Such IoT or RC devices may then not be reachable by the network for intermittent periods of time, in particular when power-savings mode (PSM) or Cellular IoT (CIoT) features are in use by the UE. Using existing technology, to increase the frequency of the monitoring cycle by IoT or RC UEs for incoming NES re-configuration signaling would then accordingly decrease their battery life or standby times. Using existing technology, the network may then not be able to benefit from NES gains when IoT or RC UEs are present in the network deployment, or only at the expense of a greatly decreased battery life or standby time for IoT or RC UEs.

Therefore, there is need for apparatuses and methods to adjust the reception or transmission behavior of IoT or RC UEs when a BS operates according to a network energy savings feature such as a BS transmission or reception bandwidth adaptation.

A second issue relates to support for dynamic cell on/off functionality for network energy savings such as when cell DTX/DRX operation, or configuration or adaptation of common channels/signals for network energy savings in a network deployment where IoT or RC UEs may be present.

For example, IoT or RC UEs may operate on a capacity layer such as a serving cell in bands n41 (2.6 GHz) or n78 (3.7 GHz). For example, using Rel-18 NR, an SSB-less SCell can be activated by relying on reference inter-band cell, or using Rel-19 NR, on-demand SSB may be provided for a UE, but such features are only available for UEs supporting carrier aggregation. However, the IoT or RC UEs may not support carrier aggregation to reduce the implementation cost and cannot support such Rel-18 or Rel-19 NES features.

Therefore, there is a need for apparatuses and methods to increase or decrease a transmission or reception activity of IoT or RC UEs when operating on a cell in which NES SCell enhancements are supported for non-IoT/RC UEs based on the carrier aggregation feature.

For example, IoT or RC UEs may operate on a coverage layer such as a serving cell in band n5 (800 MHz). Using the existing Rel-18 NR cell DTX/DRX operation, the BS may provide a pattern with a duration of up to 10.24 sec corresponding to a cell DTX or a cell DRX or a combined cell DTX/DRX pattern period wherein the period can start with a cell DTX or DRX on-duration of up to 1600 msec. Using existing technology such as eMTC operation according to Rel-13 LTE, a DL reception or UL transmission activity by the UE can be enabled/disabled for certain subframes using a valid/invalid subframe bitmap of up to 40 msec duration. However, the possible UL transmission activity from the IoT or RC UE in RRC_CONNECTED mode cannot be controlled by the BS at the larger timescale supported by the Rel-18 NR cell DTX/DRX operation. For example, some IoT or RC devices may not support DL data receptions or UL data transmissions in RRC_CONNECTED mode. These UEs may instead transmit or receive DL or UL data and control using the SDT feature. Therefore, Rel-18 NR cell DTX/DRX operation may not be applied when such UEs are present in a network deployment. For example, some IoT or RC devices may be implemented without support for C-DRX operation in RRC_CONNECTED mode. Therefore, the use of C-DRX on-durations and/or an adjustment of active time as a function of DL reception for such UEs according to the Rel-8 LTE or Rel-15 NR C-DRX operation or Rel-18 NR cell DTX/DRX operation may result in an increased UE implementation complexity. For example, some IoT devices may implement the PSM feature wherein a possible UL transmission activity is subject to timers and/or a transmission/reception schedule which are coordinated between the UE, the BS and the CN. Therefore, the use cell DTX/DRX operation by the BS for network energy savings may be rendered impractical due to the resulting interruptions from cell DTX/DRX operation with respect to an expected UE-CN reception or transmission schedule. For example, using Rel-19 NR and configuration/adaptation of common signals/channels, a number of SSB monitoring occasions in a period and/or a number of PRACH transmission opportunities may be adjusted by the BS according to its NES state or mode.

Therefore, there is need for apparatuses and methods to adjust the reception or transmission behavior of IoT or RC UEs when a BS operates according to a network energy savings feature such as cell DTX/DRX operation, or dynamic cell on/off operation, or configuration or adaptation of common channels/signals.

In one embodiment, a UE is provided by the BS with an NES signaling indication wherein the NES signaling indication is associated with a parameter corresponding to an NES state or mode of a serving cell and/or a transmission or reception behavior for frequency hopping by a reduced complexity UE. Based on the NES signaling indication, the UE determines a transmission or reception parameter associated with a frequency hopping behavior in frequency- or in time-domain for a reduced bandwidth reception or transmission in the serving cell. For example, the transmission or reception parameter may correspond to a number or a set of BWPs or subbands or of RBs or RBGs in which the RC UE may receive or transmit in the carrier BW based on the NES signaling indication. For example, the transmission or reception parameter may correspond to a number or a set of allowed/enabled or dis-allowed/disabled slots or symbols for frequency hopping by the RC UE in the carrier BW or may correspond to a start timing or an end timing or a duration or a number of symbols or slots within a same hopping bandwidth for a frequency hop by the RC UE, or may correspond to a transmission or reception duration corresponding to reduced bandwidth receptions or transmissions in the serving cell.

For example, a serving cell may correspond to a primary cell (PCell) or a secondary cell (SCell) or a carrier segment in a transmission or reception bandwidth or may correspond to a set of serving cells or carrier segments. For example, the UE may receive a higher layer NES configuration for reduced bandwidth receptions or transmissions by RRC and/or an NES signaling indication for reduced bandwidth receptions or transmissions by DCI or MAC-CE.

For example, the NES signaling indication may be provided to the UE by the BS based on one of or a combination of DCI-based signaling, L1 control signaling, RRC signaling, or MAC CE based signaling. Based on the NES signaling indication, the UE can further determine or adjust a transmission or reception parameter associated with a frequency hopping behavior in frequency-domain or in time-domain across BWPs or subbands or within a virtual/reference BWP, or a parameter associated with a transmission or a reception activity for reduced bandwidth receptions or transmissions such as a frequency hopping sequence or pattern in a set of BWPs or subbands or a virtual/reference BWP.

For example, a configuration associated with the NES state or mode of a serving cell may be provided to the UE by higher layers. For example, a DCI-based indication such as based on a DCI format 2_9 may be used to provide the UE with information associated with the NES state or mode of a serving cell. For example, a parameter corresponding to an NES state or mode may be tabulated and/or listed by system operating specifications. A configuration for an NES state or mode may be provided by higher layers to the UE and used in conjunction with a DCI-based indication such as based on DCI format 2_9 for the UE to determine a parameter associated with an NES state or mode of a serving cell or a change thereof. If a same NES state or mode can be provided to multiple UEs, a common DCI such as based on DCI format 2_9 or a common RRC signaling message may be used. A UE-specific DCI or higher layer parameters as dedicated or common type may be used to provide information associated with an NES state or mode to a UE. A value or a set of values may be associated with a parameter for an NES state or mode of a serving cell. For example, a UE may select or determine a value from the set of values associated with an NES state or mode of a serving cell based on an index value indicated through a DCI format such as a DCI format 2_9 or through MAC-CE signaling wherein the UE may select from one or more entries provided in an RRC configuration table associated with one or more index values. The UE may determine a default condition, or a default value associated with an NES state or mode of a serving cell. For example, a default operating condition with respect to an NES state or mode of a serving cell may correspond to ‘off’ or ‘disabled’.

For example, an NES state or mode of a serving cell may be provided to the UE using higher layer signaling. For example, a UE may be provided with a configuration for an NES state or mode based on a higher layer parameter such as ServingCellConfig, PDSCH-Config, PUSCH-Config, or PDCCH-Config. For example, a PDSCH or PUSCH time-domain resource allocation (TDRA) table may be configured for the UE by higher layers and include a parameter associated with an NES state or mode. For example, the PDSCH or PUSCH time-domain resource allocation table may include a parameter associated with an NES state or mode as a parameter provided in the configuration of a row in the PDSCH or PUSCH TDRA table. For example, the UE may be indicated an entry of the PDSCH or PUSCH TDRA table associated with an NES state or mode using a TDRA field in a DCI format. For example, a PDSCH or PUSCH TDRA table associated with an NES state or mode corresponding to a DL reception or an UL transmission may be used based on a configured grant.

For example, the UE may be provided by the BS with information for a slot or symbol type or for a set of slots/symbols on which to first or last or preferably apply a DL reception or an UL transmission behavior for reduced bandwidth receptions or transmissions in a carrier BW according to an NES state or mode. For example, the UE may be provided by the BS with a slot/symbol type or a set of slots/symbols associated with an NES state or mode of a serving cell. When the UE detects a DL signal such as a DCI format 2_9 or a DL channel on the slot/symbol type or the set of slots/symbols, the UE determines an activation or de-activation or presence or absence of the associated NES state or mode for the serving cell. The UE may then further determine a reception or transmission parameter associated with DL reception or UL transmission corresponding to a frequency-domain resource or a time-domain resource of a frequency hopping sequence or pattern in a set of BWPs or subbands or RBs or RBGs based on a NES state or mode.

For example, information may be provided to the UE by higher layers to associate a DL or UL reference signal or a DL or an UL or joint TCI state(s) or RS resource index(es) such as corresponding to an SSB or to a CSI-RS resource index with an NES state or mode corresponding to DL reception or UL transmissions by reduced bandwidth UEs in a serving cell. For example, a first TCI state may correspond to a DL reception according to a first NES state or mode, and a second TCI state may correspond to a DL reception according to a second NES state or mode, wherein the first and second modes or states can be same or different. For example, a PDSCH reception scheduled by a DCI format in a PDCCH can be associated with a first NES state or mode when the PDCCH is received in a CORESET with a first value for a search space set (group) index or for CORESET index or for a first one or two values of CORESETPoolIndex, and can be associated with a second NES state or mode when the PDCCH is received in a CORESET with a second value for a search space set (group) index or for CORESET index or for a second value of CORESETPoolIndex, wherein the first and second NES state or mode can be same or different.

For example, a transmission or reception parameter of an NES state or mode associated with a frequency hopping behavior in frequency- or in time-domain for a reduced bandwidth reception or transmission in the serving cell such as indicated to the UE by a DCI format 2_9 or provided by higher layers may correspond to one or more of the following:
a BWP or a subband or a set of BWPs or subbands, or a set of RBs or RBGs which are allowed, enabled or indicated or not allowed, disabled or not indicated for frequency-hopping
a hopping bandwidth or a hopping distance, e.g., a number of RBs or RBGs or a fraction of a reference bandwidth
a hopping duration, e.g., a number of symbols or slots in a same BWP or subband or RB allocation
a hopping type, e.g., a pattern such as cyclic or pseudo-random, or intra- or inter-slot hopping, or hopping ‘enabled’ or ‘disabled’
a hopping sequence number or a cyclic shift or a hopping group
a hopping timing, e.g., a start or and end timing, or a duration corresponding to a first and a second hop, or a timing reference corresponding to a hopping pattern or sequence
a symbol or slot type associated with a frequency hopping behavior, e.g., ‘D’ or ‘F’ or ‘U’, or ‘simultaneous Tx-Rx’ or ‘no simultaneous Tx-Rx’ or ‘SBFD’ or ‘non-SBFD’, or
a symbol or slot type associated with a network energy saving state, e.g., ‘DTX’ or ‘non-DTX’ or ‘DRX’ or ‘non-DRX’, or
a symbol or slot type associated with a frequency hopping behavior, e.g., ‘valid’ or ‘invalid’ or ‘enabled’ or ‘disabled’
a DL signal/channel type or format associated with a frequency hopping behavior such as a PDCCH, or PDSCH, or CSI-RS, or PTRS, or a DL configuration such as a CORESET and/or Search Space Set (Group)
an UL signal/channel type or format associated with a frequency hopping behavior such as PUCCH, or PUSCH, or PRACH, or SRS
a QCL assumption, or a value or a set of TCI states associated with a frequency hopping behavior
a TRP or TRPs, e.g., TRP A and/or TRP B, or a CORESETPoolIndex associated with CORESETs for PDCCH receptions, or a TRP identified by one or more SS/PBCH blocks (SSBs)

For example, the NES signaling indication corresponding to reduced bandwidth receptions or transmissions may be carried by PDCCH in a serving cell based on a group-common DCI format such as DCI format 2_9. For example, the NES signaling indication may be received in the cell DTX Active Time and provide information to the UE if the UE should adjust its frequency hopping behavior for the same serving cell or same serving cell group or another serving cell or another serving cell group. In another example, the NES signaling indication corresponding to reduced bandwidth receptions or transmissions may be carried by a UE-specific DCI format such as based on DCI format 1_0/0_0/1_1/0_1/1_2/0_2/ . . . for a same serving cell or serving cell group or another serving cell or another serving cell group. The NES signaling indication may be applied with respect to receptions or transmission by the RC UE on a PCell or on an SCell. For example, the NES signaling indication for reduced bandwidth transmissions or receptions may correspond to a new DCI format, or to a new/additional field or information block in a new or an existing DCI format, or to a separate higher layer provided configuration for which indication by an existing field or information block in a DCI format is reused or repurposed.

For example, an NES signaling indication associated with a reduced bandwidth reception or transmission in a DCI format such as based on DCI format 2_9 may comprise a block number 1, block number 2, . . . , block number N. In one example, a first subset of blocks may be used for indication to one or more non-RC UEs, and a second subset of blocks may be used for indication to one or more RC UEs. For example, when the first and the second subset are consecutive, a separate starting position of a block associated with a serving cell may be determined by the parameter positionInDCI-cellDTRX for a non-RC UE and by a separate parameter positionInDCI-RCcellDTRX for a RC UE. For example, a bit in a block may correspond to a frequency-hopping behavior for an RC UE such as corresponding to cell DTX or cell DRX or cell DTX and cell DRX operation as configured by higher layers for an RC UE with respect to a serving cell or a serving cell group. For example, a block length may be a same or different for a non-RC UE and a RC UE, respectively. In one example, a block length may correspond to L=3 bits for RC UEs to indicate a transmission or reception behavior associated with an NES state or mode of the cell, and a block length may correspond to L=2 bits for non-RC UEs.

For example, an existing block such as in DCI format 2_9 of the Rel-18 NR specifications may be re-used for the NES signaling indication for a RC UE. A new UE reception or transmission behavior with respect to a BWP or subband on the PCell or SCell is provided to the UE based on a new higher layer parameter nesConfigRC. For example, in case of DCI format 2_9, a block may correspond to L=1 or L=2 bits wherein a bit may correspond to a frequency hopping behavior for an RC UE such as corresponding to a cell DTX or a cell DRX or a cell DTX and cell DRX operation as configured by higher layers for a RC UE. Re-using an existing block such as DCI format 2_9 can provide a reduced specification impact, a reduced UE implementation effort, or signaling sharing between device types.

For example, a UE is provided by higher layers from a serving BS a new parameter, for example nesConfigRC, for reception of a NES signaling indication in a DCI format such as based on DCI format 2_9 that enables or disables reception or transmission by a reduced bandwidth UE in a DL or UL BWP or subband or for certain slots/symbols. For example, nesConfigRC can be associated with a set or a combination of BWPs or subbands such as ‘DL subband 1 and 2’ or ‘DL subband 1 and 4’ with respect to receptions by reduced bandwidth UEs from the BS or a TRP in the carrier BW. Similar implementations can be extended to DL receptions or UL transmissions by a reduced bandwidth UE using a virtual/reference BWP. For example, when the UE receives the NES signaling indication selecting one or more DL subbands or certain slots/symbols, the UE applies the frequency-hopping pattern or sequence, if configured, on the indicated BWPs or subbands or on the indicated slots/symbols based on the NES signaling indication and according to the higher layer parameter nesConfigRC.

A UE may monitor a set of PDCCH candidates in one or more CORESETs on the active DL BWP or DL subband in a corresponding search space set for reception of an NES signaling indication associated with a reduced bandwidth reception or transmission where monitoring implies receiving each PDCCH candidate and decoding according to the monitored DCI formats. For example, the NES signaling indication associated with a reduced bandwidth reception or transmission may be indicated to the UE in a common search space (CSS) set such as a Type3-PDCCH CSS set and/or using a cellDTRX-RNTI or indicated to the UE in a UE-specific search space (USS) set using a C-RNTI. A RC UE may be provided a search space set from S search space sets by higher layer parameter SearchSpace.

For example, a same or a different CORESET may be provided to an RC and a non-RC UE on a serving cell to monitor a PDCCH candidate for an NES signaling indication such as based on DCI format 2_9. For example, a CORESET to monitor for the NES signaling indication for an RC UE may be truncated or re-mapped based on the CORESET for monitoring of PDCCH by an RC UE. For example, an NES signaling indication such as based on DCI format 2_9 may use a same cellDTRX-RNTI for non-RC UEs and RC UEs or may use different/separate RNTIs such as a first cellDTRX-RNTI for a non-RC UE and a second RCcellDTRX-RNTI for a RC UE.

For example, for a non-RC UE and a RC UE, respectively, an NES signaling indication such as based on DCI format 2_9 may be provided with a same or a different association between the search space set s and a CORESET p, or with a same or different PDCCH monitoring periodicity of ks slots and a PDCCH monitoring offset of os slots, or with a same or different PDCCH monitoring pattern within a slot, indicating first symbol(s) of the CORESET for PDCCH monitoring within each slot where the UE monitors PDCCH, or with a same or different a duration of T s<ks indicating a number of slots that the search space set s exists by duration or a number of slots in consecutive groups of slots where the search space set s can exist, or a same or different bitmaps such as provided by monitoringSlotsWithinSlotGroup, that applies per group of slots and provides a PDCCH monitoring pattern indicating slots in a group of slots for PDCCH monitoring, or a same or different sets of restrictions for a certain CSS or USS type such as PDCCH a monitoring pattern may indicate only consecutive slots or not.

For example, for a non-RC UE and a RC UE, respectively, reception of an NES signaling indication such as based on DCI format 2_9 and a corresponding activation timing for reduced bandwidth transmissions or receptions by RC UEs in the carrier BW according to an NES state or mode of a serving cell may correspond to a same or a different activation timing. For example, when an RC UE receives an NES signalling indication on PDCCH in a DCI format such as DCI format 2_9 in slot m on the DL BWP or subband of a serving cell that indicates a change in activation or deactivation or a change to the NES state or mode for the serving cell, the UE operates on the serving cell according to the indicated NES state or mode starting from the first slot on the active DL BWP that does not begin before the beginning of the slot m+d_RC on the BWP or subband of the serving cell, where d_RC is a number of slots for the SCS of the BWP or subband.

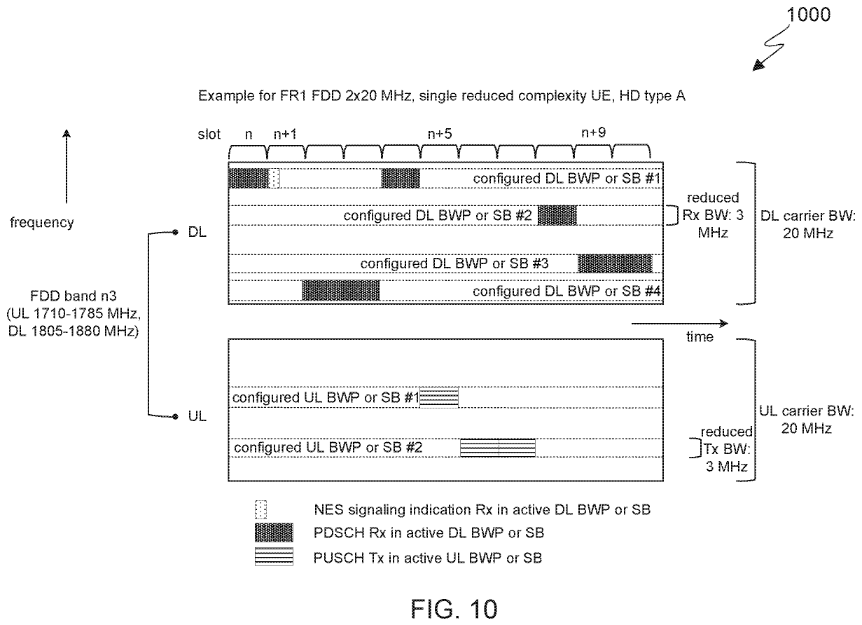

FIG. 10 illustrates a timeline 1000 of an example network energy savings (NES) signaling indication for reduced bandwidth receptions or transmissions according to embodiments of the present disclosure. For example, the NES signaling indication can be implemented by BS 102 of FIG. 1. This example is for illustration only and other embodiments can be used without departing from the scope of the present disclosure.

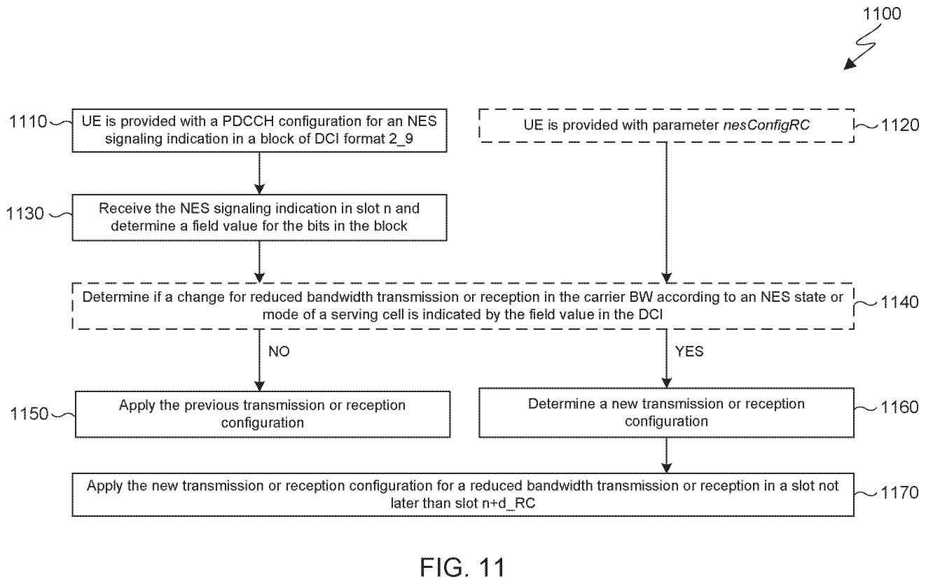

FIG. 11 illustrates an example method 1100 of NES signaling indication for a reduced complexity UE according to embodiments of the present disclosure. The method 1100 of FIG. 11 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 1100 is for illustration only and other embodiments can be used without departing from the scope of the present disclosure.

The method 1100 begins with the UE being provided with a PDCCH configuration for an NES signaling indication in a block of DCI format 2_9 (1110). Optionally, the UE is provided with parameter nesConfigRC (1120). The UE then receives the NES signaling indication in slot n and determines a field value for the bits in the block (1130). Then, optionally, the UE determines if a change for reduced bandwidth transmission or reception in the carrier BW according to an NES state or mode of a serving cell is indicated by the field value in the DCI (1140). If a change is not indicated, then the UE applies the previous transmission or reception configuration (1150). If a change is indicated, then the UE determines a new transmission or reception configuration (1160). The UE then applies the new transmission or reception configuration for a reduced bandwidth transmission or reception in a slot not later than slot n+d_RC (1170).

Although FIG. 11 illustrates one example method 1100 of the actions taken by the UE, various changes may be made to FIG. 11. For example, while shown as a series of steps, various steps in FIG. 11 could overlap, occur in parallel, occur in a different order, or occur any number of times.

In one embodiment of the present disclosure, the UE adjusts the number or the set of BWPs or subbands or RBs or RBGs in which the 6G reduced complexity or reduced capability (RC) UE may receive or transmit in the 6G carrier BW based on an NES configuration provided for a serving cell. For example, when the BS uses bandwidth adaptation to decrease or increase the BS transmission bandwidth or UE channel bandwidth for network energy savings in the cell, the RC UE accordingly adjusts the frequency hopping behavior with respect to the frequency-domain parameters of the hopping pattern. For example, the serving cell may correspond to a primary cell (PCell) or a secondary cell (SCell) or a carrier segment or a set of serving cells. For example, the UE can receive a higher layer configuration by RRC and/or an NES signaling indication by DCI or MAC-CE based on which the BWPs or subbands corresponding to possible receptions or transmissions by the RC UE in the 6G carrier BW are determined by the UE.

For example, a parameter associated with a frequency-domain hopping behavior across BWPs or subbands by the RC UE may correspond to a number or a set of BWPs or subbands or RBs or RBGs for frequency hopping, or a frequency hopping bandwidth, or a minimum or maximum frequency separation for frequency hopping.

In one embodiment, the UE determines a number or a set of BWPs or subbands available for frequency hopping in a carrier bandwidth for transmission or reception based on an NES signaling indication or an NES state or parameter of a serving cell.

In one example, the UE is configured for operation in bandwidth parts (BWPs) in a serving cell. The UE determines a DL carrier BW. The UE is provided by the BS with a set of DL BWPs for receptions by the UE in a DL carrier BW, i.e., a DL BWP set N_{BWP}. At time T1 the UE receives in an active DL BWP from a set of configured DL BWPs N_{BWP,T1}. The UE is provided with, or the UE determines a subset of configured DL BWPs F_{hop,T1} ⊂N_{BWP,T1} available for frequency hopping. For example, a size of F_{hop,T1}=N_{BWP,T1}=4. A DL reception by the UE within a slot/symbol is limited or restricted to within the active DL BWP. The UE doesn't receive a DL signal/channel outside its active DL BWP in the slot/symbol. For example, the UE may support fast BWP switching, e.g., <140 us, under certain system operation conditions. When the UE operates according to frequency-hopping, the UE may switch the active DL BWP to one of the configured DL BWPs from the set F_{hop,T1}. For example, the frequency-hopping may operate with respect to DL reception by the UE across slots, e.g., based on inter-slot frequency hopping in blocks of Nₕₒₚ slots. For example, the DL BWP switching or hopping pattern with respect to frequency domain reception occasions within the set of DL BWPs, or with respect to time-domain reception occasions in different slots may be defined by rules such as provided in system specifications or may be provided to the UE by higher layer parameters.

In the example, at a later time, the BS may adjust its NES state or mode according to system operating conditions. For example, the BS may reduce a BS channel bandwidth BW_{BS,channel} or a DL carrier BW for network energy savings from BW_{BS,channel,T1}=160 MHz to BW_{BS,channel,T2}=20 MHz. The UE may be provided by the BS with an NES signaling indication associated with a change to the NES state or mode of the cell, or the UE may determine a change to the NES state or mode of the cell based on reception of a DL signal/channel or based on a condition. At a time T2>T1, the UE may adjust the set of configured DL BWPs to N_{BWP,T2} or the set of DL BWPs available for hopping to F_{hop,T2} based on the NES signaling indication or the change in the NES state or mode. For example, a size of N_{BWP,T1}=4 may be adjusted to N_{BWP,T2}=2. For example, a size of F_{hop,T1}=4 may be adjusted to F_{hop,T2}=2. For a later DL reception, the UE then operates according to frequency-hopping based on the set of DL BWPs F_{hop,T2}. For example, when the UE operates according to inter-slot frequency-hopping in blocks of Nₕₒₚ slots, the UE may switch the active DL BWP to one of the DL BWPs available for hopping in the set F_{hop,T2}. For example, F_{hop,T1} may include BWPs {BWP 1, BWP 2, BWP 3, BWP 4} and F_{hop,T1} may include BWPs {BWP 1, BWP 3}.

Similar implementations can be applied to UL transmissions from the UE, e.g., by replacing the terms or indexations “DL” with “UL”, or “reception” with “transmission”. Similar implementations can be applied to subband based operation by replacing the term “BWP” with “subband”. Similar implementations can be applied to virtual/reference BWP based operation by the UE by replacing the terms ‘BWP’ or ‘subband’ with the restricted “RB allocation” within the virtual or reference BWP.

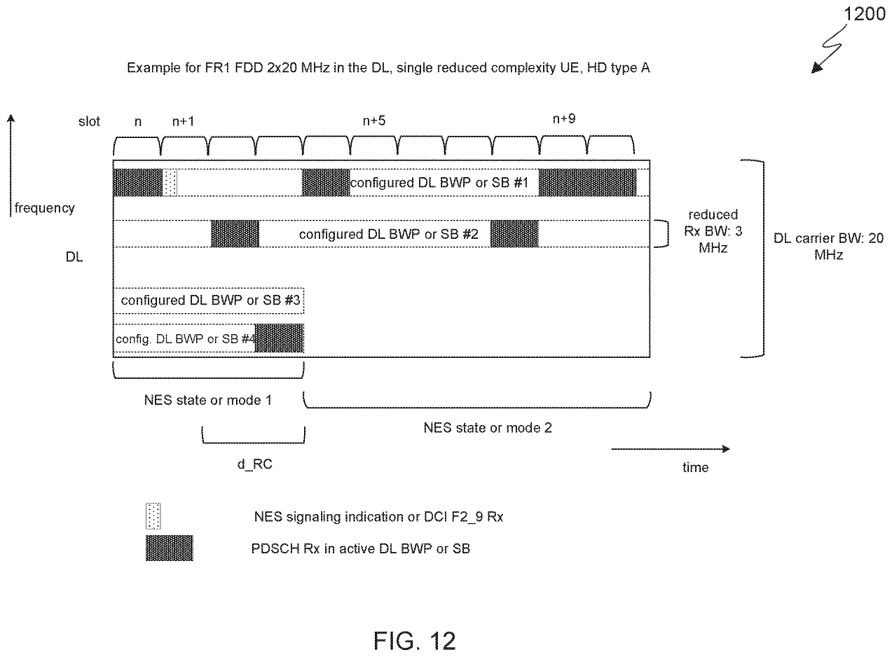

FIG. 12 illustrates a timeline 1200 of an example reduced bandwidth reception according to a change in an NES state or mode of a serving cell according to embodiments of the present disclosure. For example, the change in the NES state or mode of the serving cell can be implemented by BS 102 of FIG. 1. This example is for illustration only and other embodiments can be used without departing from the scope of the present disclosure.

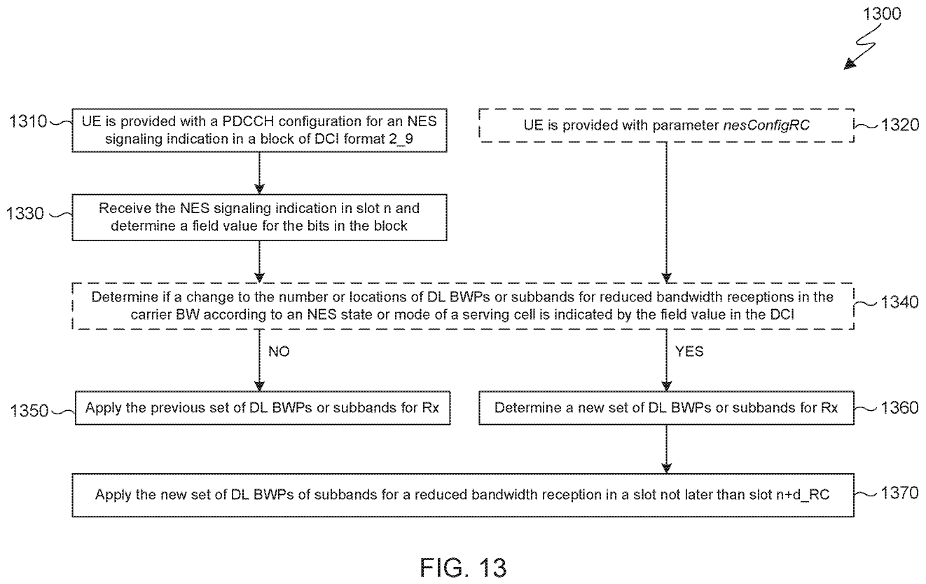

FIG. 13 illustrates an example method 1300 for reduced bandwidth reception according to a change in an NES state or mode of a serving cell according to embodiments of the present disclosure. The method 1300 of FIG. 13 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 1300 is for illustration only and other embodiments can be used without departing from the scope of the present disclosure.

The method 1300 begins with the UE being provided with a PDCCH configuration for an NES signaling indication in a block of DCI format 2_9 (1310). Optionally, the UE is provided with parameter nesConfigRC (1320). The UE then receives the NES signaling indication in slot n and determines a field value for the bits in the block (1330). Then, optionally, the UE determines if a change to the number or locations of DL BWPs or subbands for reduced bandwidth receptions in the carrier BW according to an NES state or mode of a serving cell is indicated by the field value in the DCI (1340). If a change is not indicated, then the UE applies the previous set of DL BWPs or subbands for Rx (1350). If a change is indicated, then the UE determines a new set of DL BWPs or subbands for Rx (1360). The UE then applies the new set of DL BWPs of subbands for a reduced bandwidth reception in a slot not later than slot n+d_RC (1370).

Although FIG. 13 illustrates one example method 1300 of the actions taken by the UE, various changes may be made to FIG. 13. For example, while shown as a series of steps, various steps in FIG. 13 could overlap, occur in parallel, occur in a different order, or occur any number of times.

In one example, the UE is provided with an UL subband configuration in a carrier bandwidth. The UE determines an UL carrier BW. The UE is provided by the BS with a set of UL subbands for transmissions from the UE in an UL carrier BW, i.e., a set of UL subbands N_{SB}. At time T1 the UE transmits in an UL subband from the set of provided UL subbands N_{SB,T1}. The UE is provided with, or the UE determines a subset of the provided UL subbands F_{hop,T1} ⊂N_{SB,T1} available for UL transmission based on frequency hopping. For example, a size of F_{hop,T1}=N_{SB,T1}=2. An UL transmission from the UE within a slot/symbol is limited to or restricted to within an UL subband. The UE doesn't transmit an UL signal/channel outside the UL subband in the slot/symbol. For example, the UE may support fast subband switching, e.g., <140 us, under certain system operation conditions. When the UE operates according to frequency-hopping, the UE may switch the UL subband for transmission in a slot/symbol to one of the provided UL subbands from the set F_{hop,T1} for transmission in another slot/symbol. For example, the frequency-hopping may operate with respect to UL transmission by the UE across slots, e.g., based on inter-slot frequency hopping in blocks of Nₕₒₚ slots. For example, the UL subband switching or hopping pattern with respect to frequency domain transmission occasions within the set of UL subbands, or with respect to time-domain transmission occasions in different slots may be defined by rules such as provided in system specifications or may be provided to the UE by higher layer parameters.

In the example, at a later time, the BS may adjust its NES state or mode according to system operating conditions. For example, the BS may reduce a BS channel bandwidth BW_{BS,channel} or an UL carrier BW for network energy savings from BW_{BS,channel,T1}=160 MHz to BW_{BS,channel,T2}=20 MHz. The UE may be provided by the BS with an NES signaling indication associated with a change to the NES state or mode of the cell, or the UE may determine a change to the NES state or mode of the cell based on reception of a DL signal/channel or based on a condition, as further elaborated upon. At time T2>T1, the UE may adjust the set of UL subbands to N_{SB,T2} or the set of UL subbands available for hopping to F_{hop,T2} based on the change in the NES state or mode. For example, a size of N_{SB,T1}=2 may be adjusted to N_{SB,T2}=1. For example, a size of F_{hop,T2}=2 may be adjusted to F_{hop,T2}=1. For a later UL transmission, the UE then operates according to frequency-hopping based on the set of UL subbands F_{hop,T2}. For example, when the UE operates according to inter-slot frequency-hopping in blocks of Nₕₒₚ slots, the UE may switch the UL subband for UL transmission in a slot/symbol to one of the UL subbands available for frequency hopping in the set F_{hop,T2} for UL transmission in another slot/symbol.

Similar implementations can be applied to DL receptions by the UE, e.g., by replacing the terms or indexations “UL” with “DL”, or “transmission” with “reception”. Similar implementations can be applied to operation in bandwidth parts by replacing the term “subband” with “BWP”. Similar implementations can be applied to virtual/reference BWP based operation by the UE by replacing the terms ‘BWP’ or ‘subband’ with the restricted “RB allocation” within the virtual or reference BWP.

In one embodiment, the UE determines if a transmission or a reception in a BWP or subband from a set of BWPs or subbands available for frequency hopping is allowed, enabled, or supported, or disallowed, disabled or not supported based on a NES signaling indication or an NES state or parameter of a serving cell.

In one example, the UE is configured for operation in bandwidth parts (BWPs) in a serving cell. The UE determines a DL carrier BW. For example, the DL carrier BW may correspond to a transmission bandwidth configuration N_{RB,T1}=273 PRBs, or 100 MHz, such as indicated by a SIB1, for SCS=30 kHz, and RBs numbered from 0 to 272 with respect to a common or a reference or a virtual resource grid such as a CRB reference grid. The UE is provided by the BS with a set of DL BWPs for receptions by the UE in the DL carrier BW, i.e., a DL BWP set N_{BWP}. At time T1 the UE receives in an active DL BWP from a set of configured DL BWPs N_{BWP,T1}. The UE is provided with, or the UE determines a subset of configured DL BWPs F_{hop,T1} ⊂N_{BWP,T1} available for frequency hopping. For example, a size of F_{hop,T1}=N_{BWP,T1}=4. For example, a BWP₁ is located on the RBs numbered 1 . . . 15, a BWP₂ is located on the RBs numbered 51 . . . 66, a BWP₃ is located on the RBs numbered 101 . . . 115, and a BWP₄ is located on the RBs numbered 151 . . . 166. A DL reception by the UE within a slot/symbol is limited or restricted to within the active DL BWP. The UE doesn't receive a DL signal/channel outside its active DL BWP in the slot/symbol. For example, the UE may support fast BWP switching, e.g., <140 us, under certain system operation conditions. When the UE operates according to frequency-hopping, the UE may switch the active DL BWP to one of the configured DL BWPs from the set F_{hop,T1}. For example, the frequency-hopping may operate with respect to DL reception by the UE across slots, e.g., based on inter-slot frequency hopping in blocks of Nₕₒₚ slots. For example, the DL BWP switching or hopping pattern with respect to frequency domain reception occasions within the set of DL BWPs, or with respect to time-domain reception occasions in different slots may be defined by rules such as provided in system specifications or may be provided to the UE by higher layer parameters.

In the example, at a later time, the BS may adjust its NES state or mode according to system operating conditions. For example, the BS may reduce a BS channel bandwidth BW_{BS,channel} from 160 MHz to 30 MHz, or may reduce the DL carrier BW from BW_{BS,channel,T1}=100 MHz to BW_{BS,channel,T2}=30 MHz for network energy savings. The UE may be provided by the BS with an NES signaling indication associated with a change to the NES state or mode of the cell, or the UE may determine a change to an NES state or mode of the cell based on reception of a DL signal/channel or based on a condition. For example, the DL carrier BW may correspond to a transmission bandwidth configuration N_{RB,T2}=78 PRBs, or 30 MHz, for SCS=30 kHz on RBs numbered from 100 to 177 with respect to the common or reference or virtual resource grid reference. AT time T2>T1, the UE may adjust the set of configured DL BWPs to N_{BWP,T2} or the set of DL BWPs available for hopping to F_{hop,T2} based on the change in the NES state or mode. For example, a size of N_{BWP,T1}=4 may be adjusted to N_{BWP,T2}=2. For example, a size of F_{hop,T1}=2 may be adjusted to F_{hop,T2}=1. In the example, the UE determines that the BWP₁ which is located on the RBs numbered 1 . . . 15 and the BWP₂ which is located on the RBs numbered 51 . . . 66 are located outside the transmission bandwidth configuration N_{RB,T2}, and the BWP₃ which is located on the RBs numbered 101 . . . 115 and the BWP₄ which is located on the RBs numbered 151 . . . 166 are located within the transmission bandwidth configuration N_{RB,T2}. The UE selects BWP₃ and BWP₄, or the UE excludes BWP₁ and BWP₂ but includes BWP₃ and BWP₄ from the set F_{hop,T1} for DL receptions to determine the set of DL BWPs F_{hop,T2} available for frequency-hopping. For a later DL reception, the UE then operates according to frequency-hopping based on the set of DL BWPs F_{hop,T2}. For example, when the UE operates according to inter-slot frequency-hopping in blocks of Nₕₒₚ slots, the UE may switch the active DL BWP to one of the DL BWPs available for hopping in the set F_{hop,T2}.

For example, a BWP configuration such as the set N_{BWP,T1} for DL receptions or the set F_{hop,T1} available for hopping may be provided to the UE based on a signaling indication such as a resource indicator value (RIV), or a frequency domain resource allocation (FDRA), or an RB numbering which can be defined unconstrainted by the RIV, or FDRA, or the RB numbering to provide the DL carrier BW, e.g., the signaling indication for a BWP may then not be restricted or limited to be located within the DL carrier BW. For example, the UE may maintain a set such as N_{BWP,T1} or F_{hop,T1} for a later DL reception after the change of the NES state or mode of the cell, e.g., such as when the BS changes the transmission bandwidth configuration N_{RB,T2}=78 PRBs, or 30 MHz, back to N_{RB,T1}=273 PRBs, or 100 MHz.

Similar implementations can be applied to UL transmissions from the UE, e.g., by replacing the terms or indexations “DL” with “UL”, or “reception” with “transmission”. Similar implementations can be applied to subband based operation by replacing the term “BWP” with “subband”. Similar implementations can be applied to virtual/reference BWP based operation by the UE by replacing the terms ‘BWP’ or ‘subband’ with the restricted “RB allocation” within the virtual or reference BWP.

In one embodiment, the UE determines a location or a size in frequency-domain of a BWP or a subband in a set of BWPs or subbands available for frequency hopping in a carrier bandwidth for transmission or reception based on a NES signaling indication or an NES state or parameter of a serving cell.

In one example, the UE is provided with an UL subband configuration in a carrier bandwidth. The UE determines an UL carrier BW. For example, the UL carrier BW may correspond to a transmission bandwidth configuration N_{RB,T1}=273 PRBs, or 100 MHz, such as indicated by a SIB1, for SCS=30 kHz on the RBs numbered from 0 to 272 with respect to a common or a reference or a virtual resource grid such as a CRB reference grid. The UE is provided by the BS with a set of UL subbands for transmissions from the UE in an UL carrier BW, i.e., a set of UL subbands N_{SB}. At time T1, the UE transmits in an UL subband from the set of provided UL subbands N_{SB,T1}. The UE is provided with, or the UE determines a subset of the provided UL subbands F_{hop,T1} ⊂N_{SB,T1} available for the UL transmission based on frequency hopping. For example, a frequency domain occupancy of UL subbands may be provided by associating the sequence of RBs numbered from 0 to 272 with respect to the common or the reference or the virtual resource grid such as the CRB reference grid with a first, or a second, or a third subband, etc., in order, wherein each UL subband has a same size such as 15 RBs, or 3 MHz. For example, an i^{th}UL subband in an order or sequence with respect to the common or the reference resource grid can be determined by the UE. For example, in the case of transmission bandwidth configuration N_{RB,T1}, the UE may determine 18 UL subbands. In the example, the UE then determines the starting RB of the i^{th} UL subband as RB 15*i for i=0, 1, 2, 3 . . . , 17 with reference to the resource grid. The last 3 RBs of the transmission bandwidth configuration N_{RB,T1} are not allocated to an UL subband. For example, a parameter Fₕₒₚ associated with a number of subbands available for hopping in frequency-domain may be provided to the UE. For example, Fₕₒₚ=2. The UE then hops across Fₕₒₚ UL subbands among the UL subbands in the transmission bandwidth configuration. For example, a parameter F_{hop,offset} associated with a first or lowest subband index for hopping may be provided to the UE. For example, F_{hop,offset}=3. For example, the UE determines a first or lowest UL subband and/or a number of UL subbands fully contained within the transmission bandwidth configuration to apply the parameter Fₕₒₚ associated with a number of subbands available for hopping in frequency-domain, or to apply the parameter F_{hop,offset} with respect to the first or lowest subband index for hopping. In the example, and assuming hopping across 12 of the transmission bandwidth configuration, the UE accordingly determines UL subbands 3 and 12 for the UL transmissions with frequency hopping. An UL transmission from the UE within a slot/symbol is limited to or restricted to within an UL subband. The UE doesn't transmit an UL signal/channel outside the UL subband in the slot/symbol. When the UE operates according to frequency-hopping, the UE may switch the UL subband for transmission in a slot/symbol to one of the provided UL subbands, i.e., one of UL subbands 3 or 12 for UL transmission in another slot/symbol. For example, the UL subband switching or hopping pattern with respect to frequency domain transmission occasions within the set of UL subbands, or with respect to time-domain transmission occasions in different slots may be defined by rules such as provided in system specifications or may be provided to the UE by higher layer parameters.

In the example, at a later time, the BS may adjust its NES state or mode according to system operating conditions. For example, the BS may reduce a BS channel bandwidth BW_{BS,channel} from 160 MHz to 30 MHz, or may reduce the UL carrier BW from BW_{BS,channel,T1}=100 MHz to BW_{BS,channel,T2}=30 MHz for network energy savings. The UE may be provided by the BS with a NES signaling indication associated with a change to the NES state or mode of the cell, or the UE may determine a change to the NES state or mode of the cell based on reception of a DL signal/channel or based on a condition. For example, the UL carrier BW may correspond to a transmission bandwidth configuration N_{RB,T2}=78 PRBs, or 30 MHz, for SCS=30 kHz on RBs numbered from 100 to 177 with respect to the common or the reference or the virtual resource grid. At time T2>T1, the UE adjusts the set of UL subbands available for hopping based on the change in the NES state or mode. In the example, the UE then determines UL subband 7 as the first or lowest UL subband, and UL subbands 7 to 14 as fully contained within the transmission bandwidth configuration N_{RB,T2}. For the values of Fₕₒₚ=2 and F_{hop,offset}=3 and assuming hopping across 12 of the transmission bandwidth configuration, the UE then may determine UL subbands 10 and 14 for the UL transmissions with frequency hopping. When the UE operates according to frequency-hopping at the later time T2, the UE may switch the UL subband for the later UL transmission in a slot/symbol to one of the provided UL subbands, i.e., one of UL subbands 10 or 14 for UL transmission in another slot/symbol.

Similar implementations can be applied to DL receptions by the UE, e.g., by replacing the terms or indexations “UL” with “DL”, or “transmission” with “reception”. Similar implementations can be applied to operation in bandwidth parts by replacing the term “subband” with “BWP”. Similar implementations can be applied to virtual/reference BWP based operation by the UE by replacing the terms ‘BWP’ or ‘subband’ with the restricted “RB allocation” within the virtual or reference BWP.

This disclosure provides support for BS bandwidth adaptation for network-energy savings when the RC UEs operate in the serving cell. The RC UEs can limit or reduce a hopping bandwidth or a number or a size of hopping BWPs or subbands in the DL carrier bandwidth according to a reduced BS transmission bandwidth when the BS uses a lower power NES state and can increase the hopping bandwidth or the number or the size of hopping BWPs or subbands when the BS uses a higher power NES state. Using an NES signaling indication or a UE determination of a change to the NES state or mode of the cell to adjust the frequency hopping behavior of an RC UE, such UEs may operate at reduced UE power consumption when a BS operates according to a network energy savings feature such as a BS transmission or reception bandwidth adaptation.

In one embodiment of the present disclosure, the UE adjusts the slots or symbols in which the 6G reduced complexity or reduced capability (RC) UE may receive or transmit in the 6G carrier BW based on an NES configuration provided for a serving cell. For example, when the BS uses cell DTX or cell DRX operation or configuration/adaptation of common channels/signals for network energy savings in the cell, the RC UE accordingly adjusts the frequency hopping behavior with respect to the time-domain parameters of the hopping pattern. For example, the serving cell may correspond to a primary cell (PCell) or a secondary cell (SCell) or a carrier segment or a set of serving cells. For example, the UE can receive a higher layer configuration by RRC and/or an NES signaling indication by DCI or MAC-CE based on which the slots or symbols corresponding to possible receptions or transmissions by the RC UE in the 6G carrier BW are determined by the UE. For example, a parameter associated with a time-domain hopping behavior across BWPs or subbands by the RC UE may correspond to a number or a set of allowed/enabled or dis-allowed/disabled slots/symbols or a start or an end or a duration for frequency hopping by the RC UE. For example, a parameter associated with a frequency hopping behavior across BWPs or subbands in time-domain may correspond to a number of consecutive hopping slots or symbols, or a length of a hop in a same BWP or same subband or a same set of RBs or RBGs for a hop.

For example, an intra- or inter-slot frequency hopping behavior by the RC UE with respect to a start or a duration of a hop in a frequency hopping pattern may be adjusted according to an NES parameter of the serving cell. In one example, a start or a duration of a hop according to the frequency hopping pattern of the RC UE may be defined with respect to SFN=0 when cell DTX or cell DRX is not enabled in the serving cell or may be defined with respect to an NES parameter CycleStartOffset of a cell DTX or cell DRX pattern when cell DTX or cell DRX is enabled in the serving cell. For example, when the BS uses configuration/adaptation of common channels/signals for network energy savings such as decreasing or increasing the SSB burst periodicity, the RC UE may accordingly decrease or increase a number of symbols or slots or a start or an end or a duration for frequency hopping in the 6G carrier BW as function of the SSB burst periodicity. For example, the RC UE may determine if frequency-hopping is allowed or dis-allowed in the serving cell or for a symbol/slot in the serving cell based on a cell DTX or DRX parameter. For example, the RC UE may determine a PDSCH or PDCCH or CSI-RS reception behavior for DL receptions according to an NES mode or state in a serving cell. In one example, a PDSCH or PDCCH reception in a repetition or a CSI-RS reception instance may be skipped or deferred or truncated according to the NES mode or state. For example, the RC UE may determine a PUSCH or PUCCH or SRS transmission behavior for UL transmissions according to an NES mode or state in a serving cell. In one example, a PUSCH or PUCCH or SRS transmission of a repetition may be skipped or deferred or truncated according to the NES mode or state.

In one embodiment, the UE determines a frequency hopping pattern corresponding to a transmission or reception for a slot/symbol type in a set of BWPs or subbands or RBs or RBGs based on a NES signaling indication or an NES state or parameter of a serving cell.

For example, the UE determines a set of slots/symbols, or a start, or an end, or a duration, or a hopping timing for transmission or reception using frequency hopping in a set of BWPs or subbands or RBs or RBGs based on a NES signaling indication or an NES state or NES parameter of a serving cell. For example, the UE determines if frequency hopping is allowed, enabled, or supported, or dis-allowed, disabled, or not supported in a slot/symbol for transmission or reception using frequency hopping in a set of BWPs or subbands based on a NES state or parameter of a serving cell. For example, the UE determines a hopping timing based on a NES state or parameter of a serving cell.

In one example, the UE is configured for operation in bandwidth parts (BWPs) in a serving cell. The UE determines a DL carrier BW. The UE is provided by the BS with a set of DL BWPs for receptions by the UE in a DL carrier BW, i.e., a DL BWP set N_{BWP}. At time T1 the UE receives in an active DL BWP from a set of configured DL BWPs N_{BWP,T1}. The UE is provided with, or the UE determines a subset of configured DL BWPs F_{hop,T1} ⊂N_{BWP,T1} available for frequency hopping. For example, a size of N_{BWP,T1}=4 and a size of F_{hop,T1}=2. A DL reception by the UE within a slot/symbol is limited or restricted to within the active DL BWP. The UE doesn't receive a DL signal/channel outside its active DL BWP in the slot/symbol. For example, the UE may support fast BWP switching, e.g., <140 us, under certain system operation conditions. When the UE operates according to frequency-hopping, the UE may switch the active DL BWP to one of the configured DL BWPs from the set F_{hop,T1}. For example, the frequency-hopping may operate with respect to DL reception by the UE across slots, e.g., based on inter-slot frequency hopping in blocks of Nₕₒₚ slots. For example, the DL BWP switching or hopping pattern with respect to frequency domain reception occasions within the set of DL BWPs, or with respect to time-domain reception occasions in different slots may be defined by rules such as provided in system specifications or may be provided to the UE by higher layer parameters.

In the example, the UE is provided by the BS with a first indication of valid/invalid slots/symbols corresponding to a first duration. For example, the first indication may correspond to a first subframe or slot bitmap such as provided in existing state-of-the-art higher layer parameter fdd-DownlinkOrTddSubframeBitmapBR or fdd-UplinkSubframeBitmapBR as defined in [REF 9, REF 10] and the first duration may correspond to 10 or 40 msec. For example, the first indication may correspond to a symbol/slot pattern based on a starting or end symbol such as provided by the existing state-of-the-art higher layer parameter tdd-UL-DL-ConfigurationCommon or a pattern p1 or p2 or a combination of the p1p2 patterns as defined in [REF 6].

In the example, the UE is provided by the BS with a second indication corresponding to a NES mode or state, i.e., associated with an NES reception or a transmission activity of a serving cell. For example, the second indication may correspond to a second bitmap or a second pattern corresponding to a second duration larger than the first duration, e.g., corresponding to a set of slots, subframes or radio frames. For example, the second indication may correspond to an existing state-of-the-art higher layer parameter cellDTXDRXConfig as defined in [REF 6], i.e., providing a parameter such as an onDurationTimer value and/or a CycleStartOffset value with respect to a cell DTX or cell DRX pattern. For example, the second indication may correspond to a scaling or adjustment parameter value such as {0.1, 0.2, 0.3, . . . , 1}. For example, the second indication may correspond to a timer or counter parameter value such as {1, 2, 3, . . . , 10} sec, or {1024, 2048, 4096, 9182} subframes, or a number of radio frames. For example, the second duration of the second indication may correspond to an integer multiple of the first duration of the first indication.

In the example, at time T1, the UE is provided with a first indication corresponding to a valid/invalid subframe bitmap. For example, operating in an FDD band such as n5 (UL: 824-849 MHz, DL: 869-894 MHz) using 15 kHz SCS, the UE is provided with a slot or subframe level resolution bitmap [1 1 1 1 1 1 1 1 0 0] wherein the first 8 slots/subframes corresponding to a first duration of 10 msec are valid for DL receptions, and the last 2 slots/subframes are invalid for DL receptions. A second indication is not provided. The UE determines the frequency hopping pattern with respect to time-domain reception occasions in different slots based on the first indication. For example, the UE may receive a PDCCH or PDSCH in the valid slots. For example, a PDCCH or PDSCH repetition may be postponed or dropped in an invalid slot. For example, the frequency hopping pattern with respect to the time-domain reception occasions is applied in every radio frame or repeatedly applied to multiples of four radio frames.

At a later time, the BS may adjust its NES state or mode according to system operating conditions. For example, the BS may apply a cell DTX/DRX pattern for network energy savings and provide the second indication, i.e., NES signaling indication to the UE with a value for the onDurationTimer such as 1600 msec and/or a value for the CycleStartOffset such as ‘ms10240’, or 1600 msec. A transmission from the BS or a reception by the BS is then possible in the first 1.6 sec of every 10.24 sec period with respect to SFN=0. When the UE is provided by the BS with the NES signaling indication associated with a change to the NES state or mode of the cell such as provided by the second indication, or when the UE determines a change to the NES state or mode of the cell based on reception of a DL signal/channel or based on a condition, the UE adjusts the frequency hopping pattern across the BWPs or the subbands with respect to the time-domain reception occasions in different slots based on the first and/or the second indication. For example, at time T2>T1, the UE may receive a PDCCH or PDSCH in the valid slots according to the slot or subframe bitmap [1 1 1 1 1 1 1 1 0 0] provided by the first indication in every radio frame while the value of the onDurationTimer provided by the second indication is larger than zero. For example, the frequency hopping pattern with respect to the time-domain reception occasions may be applied in every radio frame or repeatedly applied to multiples of four radio frames.

For example, the UE may determine a start or an end or a duration of a hop for the frequency hopping pattern with respect to an NES parameter CycleStartOffset of a cell DTX or cell DRX pattern when cell DTX or cell DRX is enabled in the serving cell.

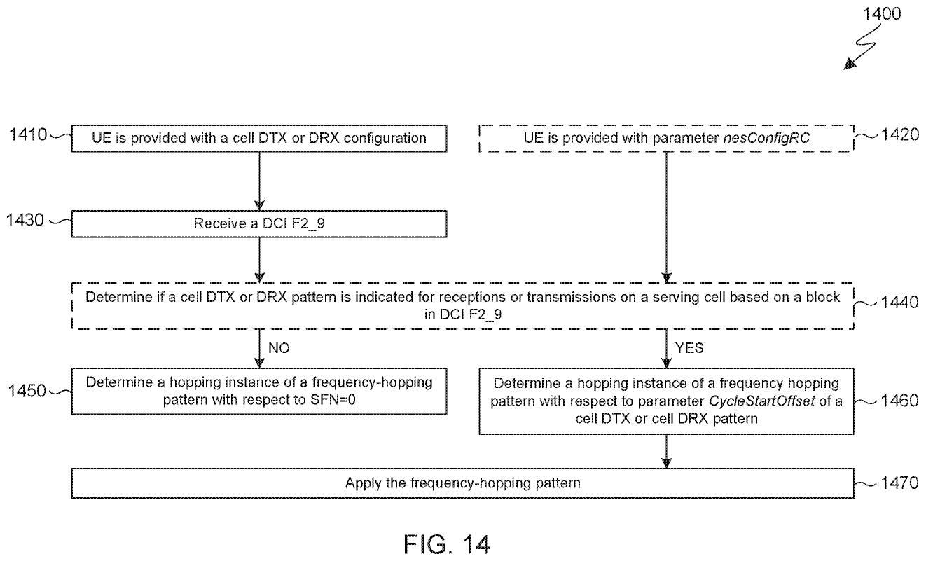

FIG. 14 illustrates an example method 1400 for hopping instance determination according to cell DTX or DRX operation on a serving cell according to embodiments of the present disclosure. The method 1400 of FIG. 14 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 1400 is for illustration only and other embodiments can be used without departing from the scope of the present disclosure.

The method 1400 begins with the UE being provided with a cell DTX or DRX configuration (1410). Optionally, the UE is provided with parameter nesConfigRC (1420). The UE then receives a DCI F2_9 (1430). Then, optionally, the UE determines if a cell DTX or DRX pattern is indicated for receptions or transmissions on a serving cell based on a block in DCI F2_9 (1440). If the cell DTX or DRX pattern is not indicated, then the UE determines a hopping instance of a frequency-hopping pattern with respect to SFN=0 (1450). If the cell DTX or DRX pattern is indicated, then the UE determines a hopping instance of a frequency hopping pattern with respect to parameter CycleStartOffset of a cell DTX or cell DRX pattern (1460). The UE then applies the frequency-hopping pattern (1470).

Although FIG. 14 illustrates one example method 1400 of the actions taken by the UE, various changes may be made to FIG. 14. For example, while shown as a series of steps, various steps in FIG. 14 could overlap, occur in parallel, occur in a different order, or occur any number of times.

For example, at time T2>T1, when the value of the onDurationTimer corresponding to the cell DTX or DRX pattern provided by the second indication has expired, the UE may determine a valid or an invalid set of slots/symbols in a duration for transmission or reception using frequency hopping in a set of BWPs or subbands based on the NES signaling indication or the NES state or parameter of the serving cell. For example, the UE may determine if frequency hopping is allowed, enabled, or supported, or dis-allowed, disabled, or not supported for a slot/symbol for transmission or reception using frequency hopping in a set of BWPs or subbands based on a NES state or parameter of a serving cell. For example, the UE may not be expected to receive a PDCCH or PDSCH repetition according to a frequency hopping pattern across BWPs or subbands if a PDCCH or PDSCH reception occasion of the PDCCH or PDSCH repetition can't be completed before expiry of the cell DTX on-duration. For example, the UE may adjust its frequency hopping pattern with respect to time-domain resources by truncating a number of hops, i.e., the UE resets or initializes a new hopping sequence for receptions in time-domain at a later reception occasion after expiry of the cell DTX on-duration.

Similar implementations can be applied to UL transmissions from the UE, e.g., by replacing the terms or indexations “DL” with “UL”, or “reception” with “transmission”. Similar implementations can be applied to subband based operation by replacing the term “BWP” with “subband”. Similar implementations can be applied to virtual/reference BWP based operation by the UE by replacing the terms ‘BWP’ or ‘subband’ with the restricted “RB allocation” within the virtual or reference BWP.

In one embodiment, the UE determines a timing of a frequency hopping pattern corresponding to a transmission or reception based on a NES signaling indication or an NES state or parameter of a serving cell.

In one example, the frequency-hopping pattern for DL receptions by the UE or for UL transmission from the UE with respect to time-domain resources may be defined with respect to an NES parameter such as a starting symbol, an offset or a value of the cell DTX or cell DRX on-duration or a cell DTX or cell DRX cycle or period. For example, in order to align the frequency hopping between different receptions by the UEs or transmissions from the UEs and to ensure that the UEs “hop” at the same time instant, the hopping instants may be defined cell-common for the frequency-hopping UEs within a cell supporting NES and the hopping instants may then be defined with respect to an NES parameter.

For example, the hopping instants may be defined or selected with respect to a value of parameter CycleStartOffset of the cell DTX/DRX pattern. For example, instead of the absolute subframe number based on the SFN=0, the hopping instants may be then counted with respect to the first slot k in a subframe or frame indicated by parameter CycleStartOffset such that the hopping takes place between slot k*Nₕₒₚ−1 and slot k*Nₕₒₚ for the frequency-hopping transmissions regardless of the start of the transmission from the UE perspective.

In one example, the UE is configured for operation in bandwidth parts (BWPs) in a serving cell. The UE determines a DL carrier BW. The UE is provided by the BS with a set of DL BWPs for receptions by the UE in a DL carrier BW, i.e., a DL BWP set N_{BWP}. At time T1 the UE receives in an active DL BWP from a set of configured DL BWPs N_{BWP,T1}. The UE is provided with, or the UE determines a subset of configured DL BWPs F_{hop,T1} ⊂N_{BWP,T1} available for frequency hopping. For example, a size of N_{BWP,T1}=4 and a size of F_{hop,T1}=2. A DL reception by the UE within a slot/symbol is limited or restricted to within the active DL BWP. The UE doesn't receive a DL signal/channel outside its active DL BWP in the slot/symbol. When the UE operates according to frequency-hopping, the UE may switch the active DL BWP to one of the configured DL BWPs from the set F_{hop,T1}. For example, the frequency-hopping may operate with respect to DL reception by the UE across slots, e.g., based on inter-slot frequency hopping in blocks of Nₕₒₚ slots. The BS transmits SSBs with an SSB burst periodicity of 20 msec.

In the example, at time T1, the UE is provided with an indication corresponding to a valid/invalid subframe bitmap. For example, operating in a TDD band such as such as n41 (UL/UL: 2496-2690 MHz) using 30 kHz SCS and a TDD UL-DL configuration of type ‘DDDSU’, the UE is provided with a slot bitmap [1 1 1 1 1 1 1 1 1 1] wherein all DL slots according to the TDD UL-DL configuration are valid for DL receptions in a first duration corresponding to 1 msec. The UE determines the frequency hopping pattern with respect to time-domain reception occasions in different slots based on the indication. For example, the UE may receive a PDCCH or PDSCH in the valid DL slots. For example, a PDCCH or PDSCH repetition may be postponed or dropped in an invalid slot. For example, the frequency hopping pattern with respect to the time-domain reception occasions is applied in every subframe or repeatedly applied to multiples of the two slots.

In the example, at a later time, the BS may adjust its NES state or mode according to system operating conditions. For example, the BS may apply SSB adaptation wherein the BS adjusts the SSB burst periodicity in the DL. For example, the BS may adjust the SSB burst periodicity from 20 msec in T1 to 80 msec in T2>T1. When the UE is provided by the BS with an NES signaling indication associated with a change to the NES state or mode of the cell, or when the UE determines a change to the NES state or mode of the cell based on reception of a DL signal/channel or based on a condition, such as a detection of the SSB burst periodicity by the UE, the UE adjusts the frequency hopping pattern across the BWPs or the subbands with respect to the time-domain reception or transmission occasions in different slots based on the NES signaling indication or the NES state or mode of the cell.

For example, at time T2>T1, the UE may decrease a monitoring of PDCCH or PDSCH reception occasions according to a less frequent SSB burst periodicity. In one example, in order to align the frequency hopping between different receptions by the UEs or transmissions from the UEs and to ensure that the UEs “hop” at the same time instant, the hopping instants may be defined cell-common for the frequency-hopping UEs within a cell supporting NES and the hopping instants may then be defined with respect to an NES parameter. For example, the hopping instants may be defined or selected according to a configuration or adaptation of common signals or channels such as based on a value of the SSB burst periodicity. In, instead of determining or synchronizing the frequency hops of the RC UEs in the cell based on SFN=0, the frequency hopping instants of the RC UEs may then be set with respect to a first slot k in a slot or subframe associated with an SSB index of the SSB burst periodicity such that the hopping takes place between slot k*Nₕₒₚ−1 and slot k*Nₕₒₚ for the frequency-hopping transmissions regardless of the start of the transmission from the UE perspective.

For example, a reception or a transmission activity may be adjusted or scaled according to a configuration or adaptation of common signals or channels such as based on a value of the SSB burst periodicity. For example, an increase or a decrease in the SSB burst periodicity may be associated with a larger or a smaller number of allowed slot/symbols for the frequency hopping pattern of a transmission or reception in a set of BWPs or subbands based on the NES state or parameter of a serving cell. For example, a scaling or adjustment of a number of allowed slots/symbols according to the NES state or parameter may correspond to a scaling factor or value such as {0.125, 0.25, 0.375, . . . , 1}, or a timer or counter parameter value such as {1, 2, 3, . . . , 16} slots. For example, an SSB burst periodicity of 20 msec in T1 may be associated with a scaling factor or value of AF_{T1}=1, i.e., receptions or transmissions using frequency hopping across BWPs or subbands are allowed on slot/symbol in every subframe/frame. For example, an SSB burst periodicity of 80 msec in T2 may be associated with a scaling factor or value of AF_{T2}=0.125, receptions or transmissions using frequency hopping across BWPs or subbands are allowed on slots/symbols in one frame every eight frames such as a first frame following the SSB instance.

Similar implementations can be applied to UL transmissions from the UE, e.g., by replacing the terms or indexations “DL” with “UL”, or “reception” with “transmission”. Similar implementations can be applied to subband based operation by replacing the term “BWP” with “subband”. Similar implementations can be applied to virtual/reference BWP based operation by the UE by replacing the terms ‘BWP’ or ‘subband’ with the restricted “RB allocation” within the virtual or reference BWP.

This disclosure provides support for BS cell DTX/DRX operation or configuration/adaptation of common channels/signals for network-energy savings when a RC UE operates in the serving cell. The RC UEs can adjust such as reduce or increase a number of slots or symbols for transmissions or receptions according to a reduced or increased BS transmission or reception activity. Using an NES signaling indication or a UE determination of a change to the NES state or mode of the cell to adjust the frequency hopping behavior of an RC UE in time-domain, such UEs may operate at reduced UE power consumption when a BS operates according to a network energy savings feature such as a cell DTX/DRX operation or dynamic cell on/off operation.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

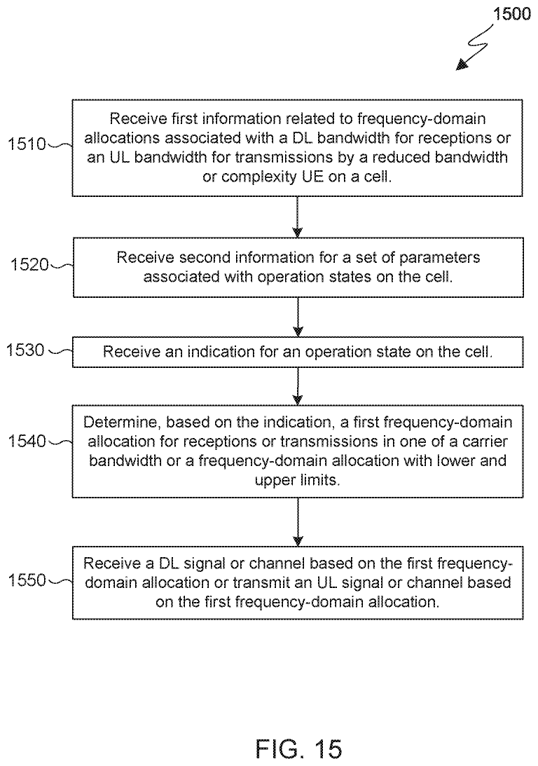

FIG. 15 illustrates an example method 1500 performed by a UE according to embodiments of the present disclosure. The method 1500 of FIG. 15 can be performed by any of the UEs 111-115 of FIG. 1, such as the UE 115 of FIG. 3, and a corresponding method can be performed by any of the BSs 101-103 of FIG. 1, such as BS 102 of FIG. 2. The method 1500 is for illustration only and other embodiments can be used without departing from the scope of the present disclosure.

The method 1500 begins with the UE receiving first information related to frequency-domain allocations associated with a DL bandwidth for receptions or an UL bandwidth for transmissions by a reduced bandwidth or complexity UE on a cell (1510). The UE then receives second information for a set of parameters associated with operation states on the cell (1520).

The UE then receives an indication for an operation state on the cell (1530). For example, in 1530, the operation state from the operation states includes parameters associated with receptions or transmissions of channels or signals on the cell in at least one of a power, spatial, time, or frequency domain. In various embodiments, the UE determines, based on the indication, a slot or symbol number, and a frequency-hopping offset value, one of a subband, a RB, a RBG, or a BWP of the first frequency-domain allocation for transmission or reception on a symbol. In various embodiments, the indication is received in DCI on a PDCCH. In various embodiments, a value for the operation state is applied with a time-domain delay after a last symbol of a DL signal or channel in which the indication is successfully decoded. In various embodiments, the operation state is associated with a configuration for cell DTX for transmissions from the cell or a DRX for receptions by the cell.

The UE then determines, based on the indication, a first frequency-domain allocation for receptions or transmissions in one of a carrier bandwidth or a frequency-domain allocation with lower and upper limits (1540). The UE then receives a DL signal or channel based on the first frequency-domain allocation or transmit an UL signal or channel based on the first frequency-domain allocation (1550).

In various embodiments, the UE determines, based on the indication, a reception or transmission parameter associated with the first frequency-domain allocation. The reception or transmission parameter corresponds to one of an EPRE value, a TCI value, a CSI resource, a CSI reporting subband size, a RBG size, or a PRG size. The UE then receives or transmits in the first frequency-domain allocation based on the reception or transmission parameter.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A method of operating a user equipment (UE), the method comprising:
receiving first information related to frequency-domain allocations associated with a downlink (DL) bandwidth for receptions or an uplink (UL) bandwidth for transmissions by a reduced bandwidth or complexity UE on a cell;
receiving second information for a set of parameters associated with operation states on the cell, wherein an operation state from the operation states includes parameters associated with receptions or transmissions of channels or signals on the cell in at least one of a power, spatial, time, or frequency domain;
receiving an indication for the operation state on the cell;
determining, based on the indication, a first frequency-domain allocation for receptions or transmissions in one of (i) a carrier bandwidth or (ii) a frequency-domain allocation with lower and upper limits; and
one of:
receiving a DL signal or channel based on the first frequency-domain allocation, or
transmitting an UL signal or channel based on the first frequency-domain allocation.

2. The method of claim 1, further comprising determining, based on (i) the indication, (ii) a slot or symbol number, and (iii) a frequency-hopping offset value, one of (i) a subband, (ii) a resource block (RB), (iii) a resource block group (RBG), or (iv) a bandwidth part (BWP) of the first frequency-domain allocation for transmission or reception on a symbol.

3. The method of claim 1, further comprising:
determining, based on the indication, a reception or transmission parameter associated with the first frequency-domain allocation,
wherein the reception or transmission parameter corresponds to one of an energy-per-resource-element (EPRE) value, a transmission configuration indicator (TCI) value, a channel state information (CSI) resource, a CSI reporting subband size, a resource block group (RBG) size, or a precoding resource group (PRG) size, and
receiving the DL signal or channel or transmitting the UL signal or channel further comprises receiving or transmitting in the first frequency-domain allocation based on the reception or transmission parameter.

4. The method of claim 1, wherein the indication is received in downlink control information (DCI) on a physical downlink control channel (PDCCH).

5. The method of claim 1, wherein a value for the operation state is applied with a time-domain delay after a last symbol of a DL signal or channel in which the indication is successfully decoded.

6. The method of claim 1, wherein the operation state is associated with a configuration for cell discontinuous transmission (DTX) for transmissions from the cell or a cell discontinuous reception (DRX) for receptions by the cell.

7. A user equipment (UE), comprising:
a transceiver configured to:
receive first information related to frequency-domain allocations associated with a downlink (DL) bandwidth for receptions or an uplink (UL) bandwidth for transmissions by a reduced bandwidth or complexity UE on a cell;
receive second information for a set of parameters associated with operation states on the cell, wherein an operation state from the operation states includes parameters associated with receptions or transmissions of channels or signals on the cell in at least one of a power, spatial, time, or frequency domain; and
receive an indication for the operation state on the cell; and
a processor operably coupled to the transceiver, the processor configured to determine, based on the indication, a first frequency-domain allocation for receptions or transmissions in one of (i) a carrier bandwidth or (ii) a frequency-domain allocation with lower and upper limits,
wherein the transceiver is further configured to one of:
receive a DL signal or channel based on the first frequency-domain allocation, or
transmit an UL signal or channel based on the first frequency-domain allocation.

8. The UE of claim 7, wherein the processor is further configured to determine, based on (i) the indication, (ii) a slot or symbol number, and (iii) a frequency-hopping offset value, one of (i) a subband, (ii) a resource block (RB), (iii) a resource block group (RBG), or (iv) a bandwidth part (BWP) of the first frequency-domain allocation for transmission or reception on a symbol.

9. The UE of claim 7, wherein:
the processor is further configured to determine, based on the indication, a reception or transmission parameter associated with the first frequency-domain allocation,
the reception or transmission parameter corresponds to one of an energy-per-resource-element (EPRE) value, a transmission configuration indicator (TCI) value, a channel state information (CSI) resource, a CSI reporting subband size, a resource block group (RBG) size, or a precoding resource group (PRG) size, and
the transceiver is further configured to receive or transmit in the first frequency-domain allocation based on the reception or transmission parameter.

10. The UE of claim 7, wherein the indication is received in downlink control information (DCI) on a physical downlink control channel (PDCCH).

11. The UE of claim 7, wherein a value for the operation state is applied with a time-domain delay after a last symbol of a DL signal or channel in which the indication is successfully decoded.

12. The UE of claim 7, wherein the operation state is associated with a configuration for cell discontinuous transmission (DTX) for transmissions from the cell or a cell discontinuous reception (DRX) for receptions by the cell.

13. Abase station (BS), comprising:
a transceiver configured to:
transmit first information related to frequency-domain allocations associated with a downlink (DL) bandwidth for receptions or an uplink (UL) bandwidth for transmissions by a reduced bandwidth or complexity UE on a cell;
transmit second information for a set of parameters associated with operation states on the cell, wherein an operation state from the operation states includes parameters associated with receptions or transmissions of channels or signals on the cell in at least one of a power, spatial, time, or frequency domain; and
transmit an indication for the operation state on the cell; and
a processor operably coupled to the transceiver, the processor configured to determine, based on the indication, a first frequency-domain allocation for receptions or transmissions in one of (i) a carrier bandwidth or (ii) a frequency-domain allocation with lower and upper limits,
wherein the transceiver is further configured to one of:
transmit a DL signal or channel based on the first frequency-domain allocation, or
receive an UL signal or channel based on the first frequency-domain allocation.

14. The BS of claim 13, wherein (i) the indication, (ii) a slot or symbol number, and (iii) a frequency-hopping offset value indicates one of (i) a subband, (ii) a resource block (RB), (iii) a resource block group (RBG), or (iv) a bandwidth part (BWP) of the first frequency-domain allocation for transmission or reception on a symbol.

15. The BS of claim 13, wherein:
the indication indicates a reception or transmission parameter associated with the first frequency-domain allocation,
the reception or transmission parameter corresponds to one of an energy-per-resource-element (EPRE) value, a transmission configuration indicator (TCI) value, a channel state information (CSI) resource, a CSI reporting subband size, a resource block group (RBG) size, or a precoding resource group (PRG) size, and
the transceiver is further configured to transmit or receive in the first frequency-domain allocation based on the reception or transmission parameter.

16. The BS of claim 13, wherein the indication is transmitted in downlink control information (DCI) on a physical downlink control channel (PDCCH).

17. The BS of claim 13, wherein a value for the operation state is applied with a time-domain delay after a last symbol of a DL signal or channel in which the indication is successfully decoded.

18. The BS of claim 13, wherein the operation state is associated with a configuration for cell discontinuous transmission (DTX) for transmissions from the cell or a cell discontinuous reception (DRX) for receptions by the cell.
